(19) United States
(12) Patent Application Publication
(10) Pub. No.: US 2025/0157258 A1
(43) Pub. Date: May 15, 2025

(54) Systems and Methods for Behavioral Analysis and AI-Enhanced Digital Biomarker Development

(71) Applicant: The Jackson Laboratory, Bar Harbor, ME (US)

(72) Inventors: Timothy L. Robertson, Bar Harbor, ME (US); Michael Ellis, Bar Harbor, ME (US); Kevin Harada, Bar Harbor, ME (US); Jamie Kiros, Bar Harbor, ME (US); Daniel Grzenda, Bar Harbor, ME (US); Juan Pablo Oberhauser, Bar Harbor, ME (US); Nicole Peltier, Bar Harbor, ME (US); Manuel Ruidiaz, Bar Harbor, ME (US); Vivek Kumar, Bar Harbor, ME (US)

(21) Appl. No.: 18/948,707

(22) Filed: Nov. 15, 2024

Related U.S. Application Data
(63) Continuation of application No. PCT/US2024/016005, filed on Feb. 15, 2024.
(60) Provisional application No. 63/599,310, filed on Nov. 15, 2023.

(51) Int. Cl. G06V 40/20; G06T 7/10; G06V 10/141; G06V 10/25; G06V 10/764; H04N 23/11

(52) U.S. Cl. CPC G06V 40/20; G06T 7/10; G06V 10/141; G06V 10/25; G06V 10/764; H04N 23/11; G06V 2201/07

(57) ABSTRACT

This disclosure describes a digitally enabled platform that includes animal (e.g., rodent) home cages with integrated cameras, cloud-based infrastructure, machine learning algorithms for generating digital biomarkers, and a user interface for collecting and visualizing continuous metrics for digital biomarkers in rats and mice. Metrics include movement, locomotion, wheel, food and water occupancy, loss of righting reflex, seizure, gait, rearing, and scratch. An array of sensors continuously monitors experimental conditions, minimizing the need for human intervention with the research subjects.

### CROSS-REFERENCE TO RELATED APPLICATION

This application claims priority to PCT/US2024/016005 filed Feb. 15, 2024 and U.S. Provisional Pat. App. No. 63/599,310, filed Nov. 15, 2023, the contents of both of which are incorporated herein by reference in their entirety.

### BACKGROUND

Conventional methods for behavioral monitoring of research animals include direct observation and automated behavioral monitoring. Direct observation involves an observer watching the animals and recording their behavior. This can be done in real time or by reviewing videos or recordings of the animals' behavior. Automated behavioral monitoring involves using sensors or cameras to track the animals' behavior without the need for a human observer. This can be a more objective and efficient way to monitor behavior, but it can also be more expensive and less flexible than direct observation. In some automated applications, researchers are using wearable sensors to track the animals' heart rate, body temperature, and other physiological measures. This information can be used to identify changes in the animals' stress levels and to assess their overall well-being.

While there have been significant advances in quantifying animal behavior, utilization of emerging technologies, which can enable rich visual metrics and real-time analytics to enable digital biomarker (DB) development, has not yet been fully realized. Furthermore, standard approaches to behavioral phenotyping often lack scalability to accommodate complex studies and require specialized experts to operate. Accordingly, a need exists for systems and methods that more efficiently and more accurately provide automated behavioral monitoring of laboratory animals.

### SUMMARY

This disclosure describes a digitally enabled platform that includes animal (e.g., rodent) home cages with integrated cameras, edge computing component, cloud-based infrastructure, machine-learning (ML) algorithms for generating digital biomarkers (DBs), and a user interface for collecting and visualizing continuous metrics for DBs in animals such as rats and mice. Metrics include movement, locomotion, wheel, food and water occupancy, loss of righting reflex, seizure, gait, rearing, and scratching behaviors. An array of sensors is provided that continuously monitors experimental conditions, minimizing the need for human intervention with the research subjects. High-definition cameras live-stream animal activity 24/7 in Ultra High Definition (UHD) 4K resolution at 30 fps to the cloud. These data can be accessed by veterinary professionals and scientists of animal behavior through an easy-to-use interface, which allows intuitive live monitoring and visualization of DBs to identify significant events, including behavioral and physiological changes. An integrated data science workbench is included that provides a platform for computational scientists and biostatisticians to streamline and automate their DB and ML workflows. The system's integral deep learning module can perform multi-animal detection, segmentation, and pose estimation. Annotation and share study features built into the user interface promote collaboration among team members. The system is scalable into a multi-cage stack for complex investigations, DB development, and industrial deployment. This technology enables improved translatability, accelerated throughput, heightened utility, and increased reproducibility.

Computer vision-based behavioral monitoring of laboratory animals is an under-utilized technology in drug development. With the advent of end-to-end machine learning (ML), an opportunity emerges to enhance non-clinical studies with a dynamic, yet holistic approach to rodent phenotyping.

A digital biomarker (DB) is a measurable characteristic or trait that is collected from digital health technologies and used as an indicator of normal biological processes, pathogenic processes, or responses to an exposure or intervention.

In the clinical space, digital biomarkers are collected from digital health technologies (DHTs), or systems that uses computing platforms, connectivity, software, and sensors for healthcare and related uses. In preclinical research, digital biomarkers are collected using digital technologies like radio frequency identification, capacitive-based electrode array, and computer vision.

In a first aspect, a system is provided. The system includes a cage housing that includes a cage bottom and a cage top. The system also includes a cage data unit that includes a top-down camera configured to capture images of a top-down field of view including one or more animals housed within the cage housing. The cage data unit also includes an illumination module configured to illuminate the top-down field of view. The system also includes a housing having an opening configured to accommodate the cage housing. The system additionally includes an air handling system coupled to the cage housing and a controller operable to carry out operations. The operations include causing the top-down camera to capture images of the field of view.

In a second aspect, a rack-mounted cage system is provided. The rack-mounted cage system includes a base frame and a plurality of vertical members coupled to the base frame. The rack-mounted cage system also includes a plurality of bays formed by spaces between the plurality of vertical members. At least a portion of the plurality of bays includes a cage data unit. The system also includes a cage housing having a cage top and a cage bottom. The cage data unit also includes a top-down camera configured to capture images of a top-down field of view including one or more animals housed within the cage bottom. The cage data unit also includes an illumination module configured to illuminate the top-down field of view. The cage data unit also includes an air handling system coupled to the cage housing. The plurality of bays also includes a controller operable to carry out operations. The operations includes causing the top-down camera to capture images of the field of view.

In a third aspect, a method is provided. The method includes receiving, by way of a central server, images of a top-down field of view. The images include live or historical images of one or more animals housed within a cage housing. The method also includes displaying, via a display, a user interface. The user interface includes a video stream viewer. The video stream viewer is configured to display a user-navigable stream of the live or historical images. The user interface also includes at least one data graph. The at least one data graph includes information indicative of at least one of: an average movement speed, a wheel occupancy, or a water dispenser occupancy. The user interface additionally includes an annotation feed. The annotation feed includes information about an animal behavior or a digital biomarker associated with the one or more animals.

In a fourth aspect, a method is provided. The method includes receiving images of a top-down field of view. The images include live or historical images of one or more animals housed within a cage housing. The method also includes determining, using a trained machine learning model, a location of a specific animal in the images. Determining the location of the specific animal includes applying an image segmentation mask. The method additionally includes assigning, using the trained machine learning model, an identifier to the specific animal. The method yet further includes assigning at least one bounding box corresponding with the location of the specific animal within the images.

In a fifth aspect, a method of training a machine learning model is provided. The method includes receiving, as training data, a plurality of images of a top-down field of view including one or more animals housed within a cage housing. The method also includes training, based on the training data, a machine learning model using an unsupervised learning method to form a trained machine learning model. The unsupervised learning method includes at least one of: K-means clustering, hierarchical clustering, or density-based clustering.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE FIGURES

FIG. 1 illustrates a system, according to an example embodiment.

FIG. 2 illustrates a rack-mounted cage system, according to an example embodiment.

FIG. 3 illustrates a method, according to an example embodiment.

FIG. 4 illustrates a method, according to an example embodiment.

FIG. 5 illustrates a method, according to an example embodiment.

FIG. 6 illustrates a schematic block diagram, according to an example embodiment.

FIG. 7 illustrates a system, according to an example embodiment.

FIG. 8A illustrates a rack-mounted cage system, according to an example embodiment.

FIG. 8B illustrates a rack-mounted cage system, according to an example embodiment.

FIG. 9 illustrates a user interface, according to an example embodiment.

FIG. 10 illustrates a focus grid, according to an example embodiment.

FIG. 11 illustrates images captured under infrared and visible illumination, according to an example embodiment.

FIG. 12 illustrates a cross-sectional schematic drawing indicating multiple focal planes, according to an example embodiment.

FIG. 13 illustrates several user interface screen shots, according to an example embodiment.

FIG. 14 illustrates several user interface screen shots, according to an example embodiment.

FIG. 15 illustrates several user interface screen shots, according to an example embodiment.

FIG. 16 illustrates several user interface screen shots, according to an example embodiment.

FIG. 17 illustrates an animal tracking and identification scenario, according to an example embodiment.

FIG. 18 illustrates a camera initialization/optimization scenario, according to an example embodiment.

FIG. 19 illustrates an animal tracking scenario, according to an example embodiment.

FIG. 20 illustrates several ear tags, according to an example embodiment.

FIG. 21 illustrates an ID classifier scenario, according to an example embodiment.

FIG. 22 illustrates an animal identification scenario, according to an example embodiment.

FIG. 23 illustrates a convolutional neural network, according to an example embodiment.

FIG. 24 illustrates results of an animal identification scenario, according to an example embodiment.

FIG. 25 illustrates an animal activity tracking scenario, according to an example embodiment.

### DETAILED DESCRIPTION

Examples of methods and systems are described herein. It should be understood that the words “exemplary,” “example,” and “illustrative,” are used herein to mean “serving as an example, instance, or illustration.” Any embodiment or feature described herein as “exemplary,” “example,” or “illustrative,” is not necessarily to be construed as preferred or advantageous over other embodiments or features. Further, the exemplary embodiments described herein are not meant to be limiting. It will be readily understood that certain aspects of the disclosed systems and methods can be arranged and combined in a wide variety of different configurations.

It should be understood that the below embodiments, and other embodiments described herein, are provided for explanatory purposes, and are not intended to be limiting.

### I. Overview

Only a small fraction of drug candidates survive to clinical trials and even less are brought to market, which puts enormous competitive pressure on pharmaceutical companies to innovate drug discovery and development. One of the challenges are limitation of in vivo studies, which due to multiple factors adopt local vivarium rules only, limiting data sharing and standardization. The unavoidable siloes created by every company impede free flow of scientific information and intellectual insights across the pharmaceutical industry and between the industry and academia. Furthermore, designing, running, and analyzing data from in vivo preclinical studies is time consuming and labor intensive. In addition, these studies depend on expert opinion and their evaluation, which creates subjectivity in the study findings. Despite numerous staff members needed to run a vivarium, animal observation and biometrics are still recorded sporadically and in a disruptive manner to animal natural activities. Collecting endpoint data from stressed animals, apart from animal welfare concerns, can impact data quality and reliability. One solution would be to use automation for animal handling and husbandry, which can significantly reduce variability and limit or completely eliminate human disruptions to the animal habitat. Such approaches have been evaluated but technical limitations have prevented their widespread adoption. Recently, computer vision and image processing powered by artificial intelligence (AI) has been successfully utilized to collect, quantify, and model animal activity. With the development of machine learning and massive cloud data transfer capabilities, video analytics can be feasibly and economically acquired, stored, integrated, and analyzed to gain novel insights from that data. In order to develop clinically relevant biomarkers from in vivo research, a robust pipeline of data acquisition, processing, analysis, visualization, and scientific collaboration is needed. Thus, an integrated and scalable rodent cage system has been built, enabling AI-enhanced digital biomarker development via continuous computer vision-based behavioral analysis performed seamlessly on the cloud, with an instant access to acquired video and animal metrics. The system results in an efficient and collaborative platform that can enable effective DB development, validation, adoption, and regulatory acceptance.

### II. Example Systems

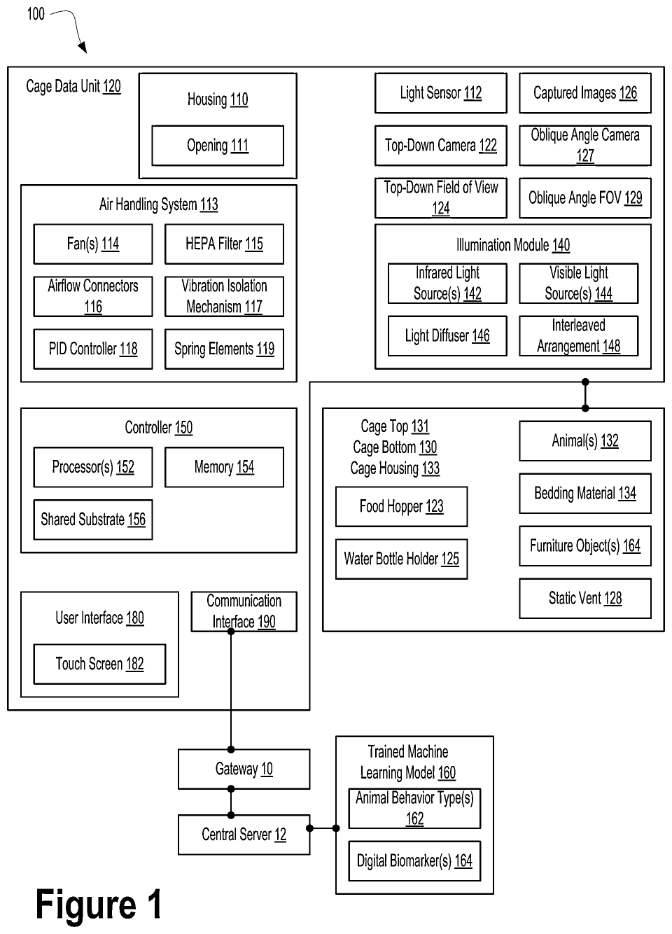

FIG. 1 illustrates a system 100, according to an example embodiment. Various elements of the system 100 can be based on a disposable mouse/rat bottom cage, with a tall design to meet EU animal housing standards and facilitate multi-animal husbandry.

System 100 includes a cage top 131 that is attachable to a cage bottom 130 so as to form a cage housing 133. The cage housing 133 can be configured to house one or more animals 132. In some examples, the one or more animals 132 can include one or more mice or rats. Other animals that can be observed within a physical housing or within a predetermined space are possible and contemplated.

System 100 also includes a cage data unit 120. The cage data unit 120 includes a top-down camera 122 configured to capture images 126 of a top-down field of view 124, through the cage top 131 and toward the cage bottom 130.

In some examples, the cage housing 133 can include a food hopper 123. The food hopper 123 can be sized for two 500-gram rats with a wide feeding area to minimize aggression. The cage housing 133 can also include a water bottle holder 125. In such scenarios, the water bottle holder 125 can hold up to 600 mL of water with two drinking locations. The cage is designed with in-cage food, water and running wheel placement to minimize occlusion of subjects for proper camera focus. In other words, at least one of the food hopper 123 or the water bottle holder 125 can be shaped to so as to reduce occluding of the top-down field of view 124. Side viewing slots are sized and located to minimize climbing and enable food and water level by animal care technicians. It will be understood that the food hopper 123, water bottle holder 125, and other aspects of the cage housing 133 can vary based on the number of housed animals and/or the type of animal.

In some embodiments, the cage housing 133 can additionally include a static vent 128 along a front surface of the cage top 131. In such scenarios, the static vent 128 can be air permeable and act to provide ventilation for the cage housing 133 in the case of power loss or other eventualities.

In various examples, the cage bottom 130 can be configured to attachably couple to the cage top 131. In such scenarios, the cage bottom 130 and cage top 131 can be sized in compliance with European Directive 2010/63/EU. Additionally or alternatively, the cage bottom 130 and the cage top 131 can include a clear plastic material. As an example, the clear plastic material can include polyethylene terephthalate glycol (PETG). In such scenarios, the top-down camera 122 can be configured to capture images through the transparent cage top 131 material. Furthermore, the cage bottom 130 can be shaped so as to include at least 80 in² (516.13 cm²) of floor space. Also, in some embodiments, sidewalls of the cage bottom 130 and cage top 131 can be at least 5 inches high. In some examples, the cage bottom 130 can be covered with a bedding material 134. In such embodiments, the bedding material 134 can include at least one of: paper bedding, wood shavings, corncob, or cellulose-based paper (e.g., Alpha Dry).

In example embodiments, cage data unit 120 can include two cameras placed in different positions (e.g., top and top-side) and having different fields of view (e.g., top-down and oblique angle). In various examples, the cameras can be capable of recording at 4032×3040 pixel resolution at 30 fps. For instance, the top-down camera 122 can be configured to capture images at Ultra High Definition (UHD) 4K resolution at 30 frames per second. It will be understood that other camera resolutions and frame capture rates are possible and contemplated herein.

In some embodiments, the cage data unit 120 can also include an oblique angle camera 127. In such scenarios, the oblique angle camera 127 is configured to capture images of an oblique angle field of view 129. For example, the oblique angle camera 127 can be configured to capture images at 2K (e.g., 2560×1440 pixels) resolution at 30 frames per second.

The cage data unit 120 also includes an illumination module 140 configured to illuminate the top-down field of view 124. In some embodiments, the illumination module 140 can include a plurality of infrared light sources 142. For example, the plurality of infrared light sources 142 can include one or more 940 nm near-infrared (NIR) light-emitting diodes (LEDs). It will be understood that infrared light sources that emit light at other infrared wavelengths (e.g., 900 nm or longer) are possible and contemplated. In some embodiments, the emission wavelength of the infrared light sources 142 can be selected based the observable wavelengths of light of the animals. As an example, the emission wavelength of the infrared light sources 142 can be outside the visible range of the animals, so as to be imperceptible to them. The illumination module 140 also includes a plurality of visible light sources 144. In some examples, the plurality of visible light sources 144 can include one or more 5000K White LEDs, which can provide 100 lux illumination (at cage floor). In some cases, visible light sources 144 can be utilized during daytime operations and infrared light sources 142 can be utilized during nighttime operations. In various embodiments, illumination module 140 can be configured to illuminate cage housing 133 through the transparent material of the cage top 131. In other words, cage data unit 120 is a collection of electronics, cameras, and housings that are mostly located above cage housing 133 while it is inserted in the opening 111. In such scenarios, cage housing 133 can be easily removed from cage data unit 120 and opening 111 without a lengthy or complex disconnection process.

In examples, the plurality of infrared light sources 142 and the plurality of visible light sources 144 can be disposed in an interleaved arrangement 148. In such scenarios, the interleaved arrangement 148 can be selected so as to uniformly illuminate cage housing 133 with visible light and/or infrared light. In various examples, illumination module 140 can include a light diffuser 146 that can be disposed along a downward facing surface of the opening 111. Light diffuser 146 can beneficially redirect/refract light in a diffuse manner so as to more evenly distribute light along the floor.

Illumination module 140 is a fully controllable cage illumination system that provides 5000K White LED with 100 lux (at cage floor) during the day and 940 nm near-infrared (NIR) LED with minimal circadian impact during the night. The system has LED persistence that ensures no illumination change during soft reboots and robust LEDs. Furthermore, cage data unit 120 can include an illumination sensor (e.g., light sensor 112) to determine ambient lighting. In such scenarios, illumination module 140 can be controlled based on the amount of ambient light.

Cage data unit 120 additionally includes a housing 110 having an opening 111 configured to accommodate cage top 131 and cage bottom 130, which together form cage housing 133. In some embodiments, housing 110 need not include an opening 111. In such scenarios, the cage data unit 120 and the cage housing 133 can be configured to be optically coupled to one another. Namely, the cage data unit 120 can be configured to capture images through the cage top 131 of the cage housing 133. The cage is designed with in-cage food, water, and running wheel placement to minimize occlusion of subjects for proper camera focus. Side-viewing slots are sized and located to minimize climbing and enable food and water level by animal care technicians.

The system 100 is furnished with fully controllable cage airflow. In such embodiments, the cage data unit 120 also includes an air handling system 113 coupled to the cage housing 133. In various examples, air handling system 113 can include at least one fan 114. As an example, air handling system 113 can provide dedicated supply and exhaust fans with flow rates up to 20 liters per minute (LPM). Air handling system 113 can additionally include a HEPA filter 115. For example, HEPA filter 115 can include one or more high-grade 99.999% HEPA filters that can create positive or negative cage pressure. The air handling system 113 can include one or more airflow connectors 116 and a vibration isolation mechanism 117. In such scenarios, vibration isolation mechanism 117 can beneficially reduce levels of vibration and/or noise, which can adversely affect the animals 132. Yet further, air handling system 113 can include one or more medical-grade flow sensors, which can be configured to continuously measure airflow into and/or out of the cage housing 133. In case of a power loss, a cage top filter (e.g., static vent 128) can provide a sufficient air flow.

In various examples, vibration isolation mechanism 117 can include a plurality of spring elements 119 that couple the at least one fan 114 to the housing 110. In such embodiments, the plurality of spring elements 119 can be configured to dampen vibrations caused by operation of the at least one fan 114. By damping the vibrations of the at least one fan 114, potential impacts to the housed animals due to sound and/or vibration can be beneficially minimized.

In some scenarios, air handling system 113 can additionally include a PID controller 118, wherein “PID” stands for Proportional, Integral, and Derivative. These are three terms that are used to calculate the output of the controller. The proportional term is calculated as the difference between the setpoint and the actual process value. The larger the difference, the larger the output of the controller. The integral term is used to eliminate the steady-state error. It is calculated as the sum of the errors over time. The integral term will increase the output of the controller as long as there is an error. The derivative term is used to prevent overshoot. It is calculated as the rate of change of the error. The derivative term will decrease the output of the controller as error increases.

The PID controller 118 can be configured to control the at least one fan 114 so as to provide a constant pressure or constant flowrate of air to the cage housing 133 when within the opening 111 of the housing 110. The PID controller 118 can act as a control loop mechanism employing feedback to provide continuously modulated control of airflow into cage housing 133.

In some embodiments, cage housing 133 and/or air handling system 113 can include a plurality of airflow connectors 116 configured to connect a rear surface of the cage housing 133 to the air handling system 113. In such scenarios, airflow connectors 116 are configured to attachably couple to air handling system 113 when cage housing 133 is mounted within opening 111.

The cage data unit 120 yet further includes a controller 150 operable to carry out operations. These operations include causing the top-down camera 122 to capture images 126 of the top-down field of view 124. It will be understood that the operations of controller 150 can relate to controlling many functions of system 100, as described herein.

In some example embodiments, the operations of controller 150 can also include identifying one or more animals from at least a portion of the captured images. Such identifying can be performed using a trained machine learning model.

In some examples, these operations also include assigning a bounding box based on a respective identified animal and determining a centroid of the bounding box.

Yet further, the operations can include determining a segmentation mask within the bounding box.

In some examples, the operations can include classifying at least a portion of the captured images 126, using a trained machine learning model 160, as being associated with at least one animal behavior type from a plurality of animal behavior types 162. The plurality of animal behavior types 162 includes movement, locomotion, wheel, food and water occupancy, loss of righting reflex, seizure, gait, rearing, and scratching. It will be understood that other animal behavior types 162 are possible and contemplated.

The operations can additionally include assigning, to at least a portion of the captured images 126 using a trained machine learning model 160, at least one digital biomarker from a plurality of digital biomarkers 164. In such scenarios, the plurality of digital biomarkers 164 can include heart rate, respiration rate, size, weight, sleep pattern, physical activity, electrodermal activity (EDA), and skin temperature. Additionally or alternatively, digital biomarkers 164 can include coat condition, eye clarity, presence, absence, condition of lesions, posture, loss of righting reflex, seizure state, seizure type, overall animal health, disease state, scratching, and assessment of various activities including marble burying or nest building. It will be understood that other digital biomarkers 164 are possible and contemplated.

In various examples, the controller 150 can include a plurality of processors 152, such as a graphics processor unit (GPU) and a central processor unit (CPU), and a memory 154. In various embodiments, the GPU, the CPU, and the memory 154 can be coupled to a shared substrate 156. Additionally or alternatively, the controller can be specifically configured to perform machine learning tasks. As an example, the controller 150 can be an NVIDIA Jetson Nano series module. Other computing modules are possible and contemplated.

In some examples, cage data unit 120 can additionally include a communication interface 190. In such scenarios, the communication interface 190 can be configured to communicatively couple the controller 150 to at least one of a gateway 10 or a central server 12.

In some example embodiments, gateway 10 can include a Supermicro box with an Intel i7 CPU and a TPM 2.0 module responsible for uploading video and metrics to the cloud. In some embodiments, gateway 10 can have 1 to 2 TB of disk space for buffering videos in case internet connectivity is lost, sufficient to buffer at least 24 hours of video. Gateway 10 connects to a hardware switch keeping the unit (e.g., system 100) logically behind gateway 10 and not visible from the site network where the unit is installed. In some embodiments, a single gateway 10 can support up to 10 cage units and AWS IoT Greengrass is used for proper communication with the unit, wherein AWS IoT Greengrass is an open-source edge runtime and cloud service that helps to build, deploy, and manage device software. Greengrass enables extension of AWS IoT capabilities to devices so they can collect and analyze data locally, react to local events, and communicate securely with each other. AWS Greengrass also orchestrates the Docker containers to automate the deployment of data in a consistent, useful and scalable manner.

To handle background processing, Redis manages task queue and uploads to cloud video-api and metrics-api. Redis is an open-source, in-memory data structure store that can be used as a database, cache, message broker, and streaming engine. Raw 4K video is uploaded to AWS customer dedicated S3 buckets and Kafka bus is employed to handle high volume, high throughput, and low-latency video and metrics streams.

In example embodiments, cage data unit 120 can include a user interface 180. In such scenarios, user interface 180 can include a touch screen 182 disposed along a front surface of the housing. Furthermore, in such examples, the operations can include in response to receiving a user command via the touch screen 182, adjusting at least one operational aspect of the system 100.

In some embodiments, cage housing 133 can include at least one furniture object 164 located along the cage bottom 130. In such examples, furniture objects 164 can include at least one of a running wheel, a rotowheel, a rotobar, or a ladder. As an example, a running wheel can provide insights on animal activity along with other objects (gnawing blocks, hiding structures), which can offer an enriched environment. Other types of furniture objects involved in the study of animal behavior are possible and contemplated.

In various examples, cage data unit 120 can also include a light sensor 112. In such scenarios, light sensor 112 can be configured to provide information indicative of an ambient light level to the controller 150. In an example embodiment, light sensor 112 can be configured to sense a brightness of ambient light in the visible and/or infrared wavelengths. The information provided from light sensor 112 can be used to control illumination module 140. For example, the operations can include, based on an ambient light level and/or a time of day, causing at least one of the infrared light sources 142 or the visible light sources 144 to illuminate the cage bottom 130.

The light sensor 112 can be utilized to control other elements of system 100. For example, the operations of controller 150 can also include adjusting an exposure setting of the top-down camera 122 based on the ambient light level and/or adjusting an acquisition mode of the top-down camera 122 based on the ambient light level.

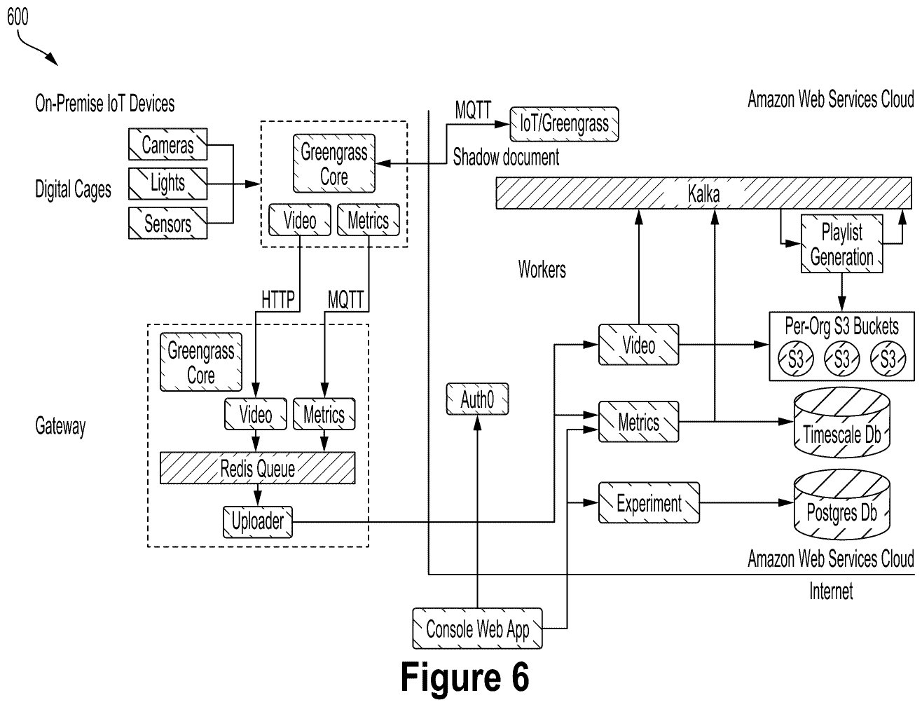

FIG. 6 illustrates a schematic block diagram 600, according to an example embodiment. Diagram 600 illustrates how digital cages (e.g., system 100) can communicatively interact with a gateway (e.g., gateway 10), cloud services (e.g., central server 12), and/or the internet. As illustrated in diagram 600, video information can be provided to the gateway by way of hypertext transfer protocol (HTTP) request and response. Various versions of HTTP (e.g., HTTP/2 or HTTP/3) are possible and contemplated.

As illustrated in diagram 600, various information or metrics can be provided from system 100 to server 10 using Message Queuing Telemetry Transport (MQTT). MQTT is a lightweight, publish-subscribe messaging protocol that can be used for connecting remote devices with a small code footprint and minimal network bandwidth.

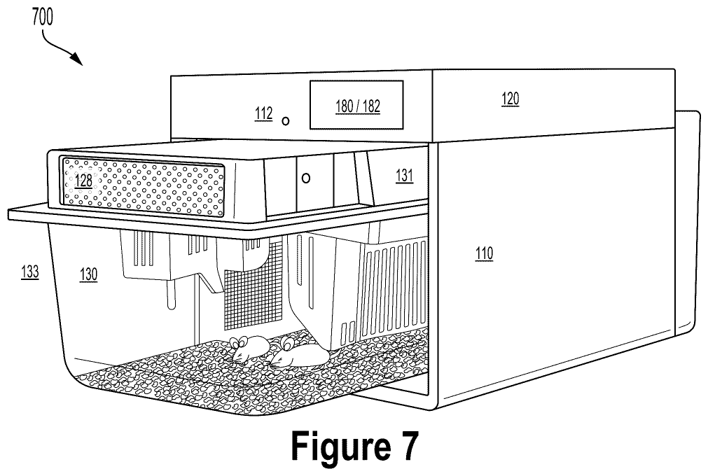

FIG. 7 illustrates a system 700, which can be similar or identical to system 100, according to an example embodiment. As illustrated in FIG. 7, system 700 can include a cage data unit (e.g., cage data unit 120) and a cage housing (e.g., cage housing 133) that can be inserted into an opening of a housing (e.g., housing 110) of the cage data unit. In some embodiments, the cage housing can include a cage top (e.g., cage top 131) and cage bottom (e.g., cage bottom 130). In various examples, the cage top can include a static vent (e.g., static vent 128).

### II. Example Rack-Mounted Cage Systems

Traditional animal husbandry racks are designed to hold many cages in a small footprint and, in some cases, to provide individual ventilation to each cage position. More recent animal husbandry racks have begun to integrate electronics into the rack to support continuous monitoring of animals or to provide feedback to operators managing animal husbandry. Disadvantageously these embedded electronics generate heat that must be managed to protect both the electronics and the animals.

Provided herein are designs for improved animal husbandry racks that use (or “leverage”) a continuous airflow and exhaust of an individually ventilated caging rack to capture and exhaust the heat from electronics associated therewith without requiring additional fans and without risking introducing unfiltered, “dirty” air into a room comprising one or a plurality of cages having experimental animals therein.

In these designs, electronics are housed in one or more sealed compartments that each have both air intake and air exhaust connected to rack blower and exhaust structures in the same manner as the individually ventilated cages, thereby leveraging these systems to accommodate and disperse electronics-associated heat.

In a further improvement to animal husbandry racks, also provided are methods for individually attaching each cage position to a horizontal plenum on the rack via a clip mechanism that holds the rails for the cage while ensuring an airtight connection for cage air intake and exhaust. By clipping on the rails for each cage position individually, the rack can be assembled modularly depending on need, with different types of cages in each cage position. For example, some of the cage positions on the rack can be outfitted with simple cage rails while others can be outfitted with a video capture top and rails to enable capture of digital biomarkers. As demand for video capture increases, non-video cage positions can be converted to video cage positions.

In a further improvement to animal husbandry racks, provided herein are home cage designs that enable continuous video and processing of said video into digital biomarkers in real time. When capturing home-cage video, to observe animals in both light and dark cycles, it is necessary to provide and illuminate each cage with both visible and infrared (IR) LEDs and for the camera to have sufficient sensitivity in both ranges of the spectrum. This can become a challenge for focusing the camera lenses because IR focuses in a different plane than visible light. The short focal lengths required in an animal husbandry cage exacerbate this focal plane separation. In the designs provided herein, each cage position is outfitted with one or more cameras viewing the cage from a top-down perspective or an oblique perspective as well as one or more GPUs systems to process the video into digital biomarkers in real time. To ensure a full view of the cage while also capturing detailed, high spatial resolution video of individual animals, the system contains more than one video camera. One wide angle camera captures the totality of the cage footprint while one or more cameras equipped with zoom lenses capture higher resolution video, wherein both visible and IR LEDs are provided to illuminate each cage. To ensure an unobstructed view of the entire cage area, in these designs are provided a food hopper, running wheel, and water bottle holders positioned on the outer edge of the cage.

In a further improvement to animal husbandry racks, provided herein are designs having a touch screen at each cage position. This touchscreen can serve as a digital cage card connected to a central system managing animals and can alert technicians managing the animals in the cages to special requirements for a particular cage or to automatically detected issues with the cage position that the technician needs to address. Because the screen has touch capabilities, a technician can input information back into a central system or use the screen to request veterinary or other support. For example, the system can alert a technician to a potential issue that requires their attention and can provide details on the screen to the nature of the issue. The technician can address the issue then input information via the touchscreen to report the status. If the issue needs to be escalated to a veterinarian or other individual of greater or different experience, the technician can escalate via the touchscreen, thereby sending an alert to the veterinarian or other individual, who can then log into the web-based system, view the cage via the live video feed, and direct the technician as to how to resolve the issue. This direction will go back to the cage-level screen and alert the technician on how to close out the issue. Once complete, the technician can then indicate status via the touchscreen.

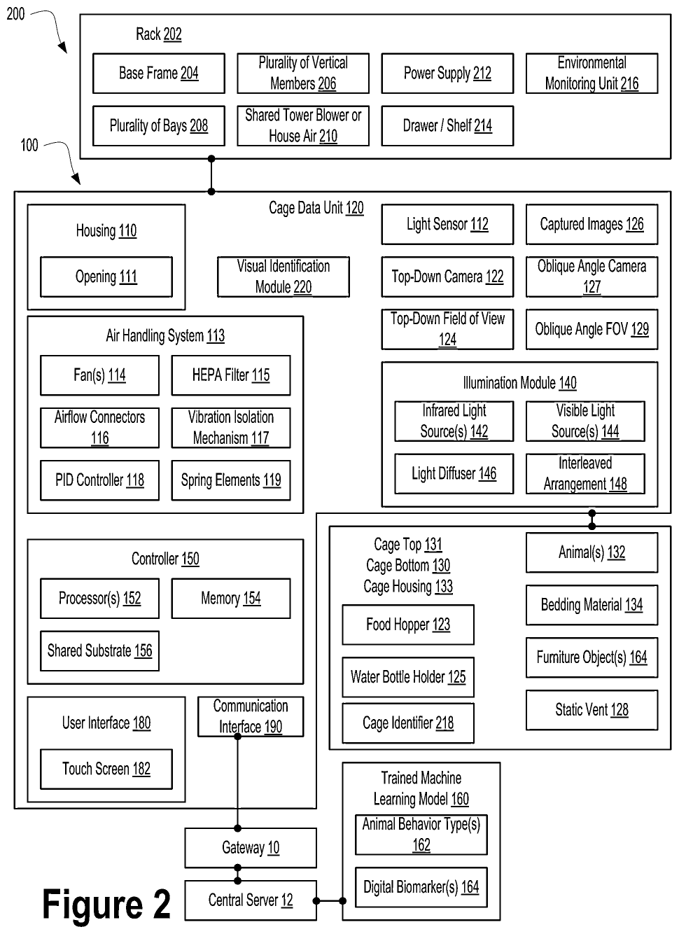

FIG. 2 illustrates a rack-mounted cage system 200, according to an example embodiment. In such embodiments, individual cage elements (e.g., system 100) can be positioned in a dedicated rack, which can contain air fans, filters, illumination, cameras, sensors, and a controller (e.g., a Jetson Nano single board computer) for component control, data acquisition, optional local processing, or data cloud transfer. Each cage of the rack-mounted cage system 200 can be specifically identified and controlled using a touchscreen for digital cage care and basic data input and readout.

The rack-mounted cage system 200 can include a base frame 204. The rack-mounted cage system 200 can also include a plurality of vertical members 206 coupled to the base frame 204. In example embodiments, the rack-mounted cage system 200 includes a plurality of bays 208 formed by spaces between the plurality of vertical members 206. In such scenarios, at least a portion of the plurality of bays can be configured to accommodate a cage system, which can be similar or identical to system 100 as illustrated and described in reference to FIG. 1. For example, each of the plurality of bays 208 can accommodate a cage data unit (e.g., cage data unit 120) having housing (e.g., housing 110). The housing can include an opening (e.g., opening 111) configured to accommodate a cage top (e.g., cage top 131) and a cage bottom (e.g., cage bottom 130). In such scenarios, the cage top is attachable to the cage bottom so as to form a cage housing (e.g., cage housing 133). In other embodiments, the housing 110 need not include an opening. In such examples, the cage housing can be configured to be optically coupled to the cage data unit. For example, the cage housing can be coupled to a rack mount system so as to be loaded proximate to the cage data unit.

As described elsewhere herein, the cage data unit can include a top-down camera (e.g., top-down camera 122) configured to capture images (e.g., images 126) of a top-down field of view (e.g., top-down field of view 124) including one or more animals (e.g., animals 132) housed within the cage housing. The cage data unit can also include an illumination module (e.g., illumination module 140) configured to illuminate the top-down field of view.

Each cage data unit can also include an air handling system (e.g., air handling system 113) coupled to the cage housing (e.g., cage housing 133) and a controller (e.g., controller 150) operable to carry out operations. The operations can include causing the top-down camera to capture images of the top-down field of view.

The operations can also include identifying one or more animals from at least a portion of the captured images. The identifying can be performed using a trained machine learning model. Additionally or alternatively, the operations can include assigning a bounding box based on a respective identified animal and determining a centroid of the bounding box. Yet further, the operations can include determining a segmentation mask within the bounding box.

In some embodiments, the operations can also include classifying at least a portion of the captured images, using a trained machine learning model (e.g., trained machine learning model 160), as being associated with at least one animal behavior type from a plurality of behavior types (e.g., behavior types 162). The plurality of animal behavior types can include movement, locomotion, wheel, food and water occupancy, loss of righting reflex, seizure, gait, rearing, and scratching. In some examples, other types of animal behaviors are possible.

Additionally or alternatively, the operations can also include assigning, to at least a portion of the captured images, using a trained machine learning model, at least one digital biomarker from a plurality of digital biomarkers (e.g., digital biomarkers 164). In various embodiments, the plurality of digital biomarkers can include heart rate, respiration rate, size, weight, sleep pattern, physical activity, electrodermal activity (EDA), and skin temperature. Additionally or alternatively, the digital biomarkers can include coat condition, eye clarity, presence, absence, condition of lesions, posture, loss of righting reflex, seizure state, seizure type, overall animal health, disease state, scratching, and assessment of various activities including marble burying or nest building.

In various embodiments, the controller can include a graphics processor unit (GPU), a central processor unit (CPU), and a memory. In such scenarios, the GPU, the CPU, and the memory are coupled to a shared substrate (e.g., shared substrate 156). In some embodiments, the controller can be configured to perform machine learning tasks. Additionally or alternatively, the controller can be an NVIDIA Jetson Nano series module. In some embodiments, the controller can include an NVIDIA Maxwell GPU, providing up to 1.4 TFLOPS of performance. The controller can include 4 GB of LPDDR4 RAM, enabling it to run multiple neural networks in parallel. The controller can also include 16 GB eMMC storage. The controller can include a MicroSD card slot, USB 3.0 ports, one or more HDMI ports, and/or one or more MicroUSB power ports.

In some examples, the rack-mounted cage system 200 can include various systems that can be distributed and/or shared between the plurality of cages in each bay. As an example, the respective air handling systems of each bay are coupled to a shared tower blower unit or house air 210. Additionally or alternatively, the rack-mounted cage system 200 can include a power supply 212. In such scenarios, at least a portion of the bays 208 and corresponding cages can be configured to receive electrical power via the power supply 212.

In various embodiments, the rack-mounted cage system 200 can include that at least a portion of the bays 208 are configured to accommodate a drawer, a shelf 214, or an environmental monitoring unit 216. In some embodiments, the environmental monitoring unit 216 can include measurement and recordation of various environmental metrics including: sound/acoustics, vibration, airflow, air quality, CO₂ and ammonia levels, temperature, and humidity.

In some embodiments, a visual cage census can be obtained using the rack-mounted cage system 200. For example, a cage identifier 218 can be disposed within the camera's field of view. The cage identifier 218 can include a bar code, QR code, an encoded pattern, or another type of visible or infrared identifier or symbol. The cage identifier 218 can be etched into the plastic, affixed with a sticker, or printed on a backside of a cage card. The cage data unit 120 can be configured to recognize the cage's identity based on the cage identifier 218 being present in an image captured by one or more of the cameras. The cage data unit 120 can use this information to associate the data acquired by a particular camera with the cage and the animals within it. This feature can beneficially enable a continuous data record as the cage is moved from slot to slot in the rack. Such a visual cage census can also provide a count of the number of cages that are in the rack, the associated number of animals, and other metrics related to keeping a census of animals in a vivarium.

In some embodiments, the rack-mounted cage system 200 can include a visual identification module that is configured to recognize a unique cage identifier 218 associated with the cage housing 133. In some embodiments, the unique cage identifier 218 can include at least one of a barcode, a QR code, or another graphical identifier. The unique cage identifier 218 can be positioned within the top-down field of view of the top-down camera. In some embodiments, the visual identification module can be operable to recognize the unique identifier from images captured by the top-down camera. In examples, the unique cage identifier 218 can be integrated into the cage housing 133 by at least one of etching into a surface of the cage, affixing a label as a sticker, or printing on a cage card. In some such examples, the operations of the controller can also include associating data captured by the top-down camera with a specific cage housing based on the recognized unique cage identifier 218. In various examples, the operations can include maintaining a continuous record of the cage housing 133 and the one or more animals within it as the cage housing is relocated within a rack-mounted cage system 200.

In some examples, the operations can also include using the recognized unique cage identifier 218 to track the number of cage housings within a rack-mounted cage system 200. The operations can also include aggregating data related to the number of animals within each cage housing. The operations additionally include providing a census of animals within a vivarium based on the tracked cage housings and aggregated animal data.

In some examples, a visual identification module 220 can include an image processing algorithm configured to decode the unique cage identifier 218 from the captured images. Additionally or alternatively, the visual identification module 220 can include a database for storing associations between decoded unique identifiers and respective cage housings.

In various embodiments, the operations can include updating the database in real-time as unique cage identifiers are recognized or as cage housings are added or removed from the rack-mounted cage system 200.

In some examples, a user interface (e.g., user interface 180 or a remote user interface) can be configured to display information relating to the census of animals, including total number of cage housings, total number of animals, and distribution of animals across different cage housings. In such scenarios, the user interface is further configured to allow manual updating of information related to specific cage housings or animals based on visual inspection or additional data inputs.

In some embodiments, the unique cage identifier is configured to be durable and resistant to environmental conditions present within the vivarium, including humidity, temperature fluctuations, and cleaning processes.

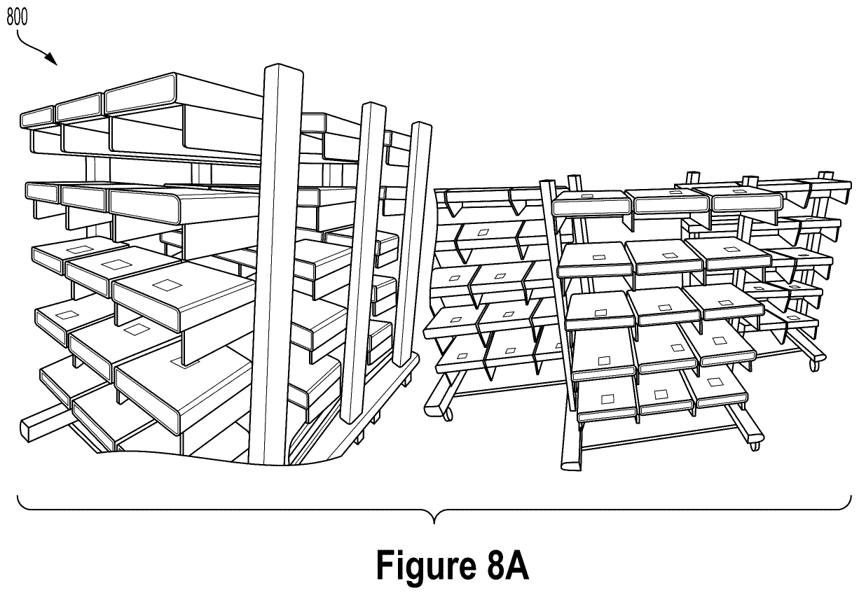

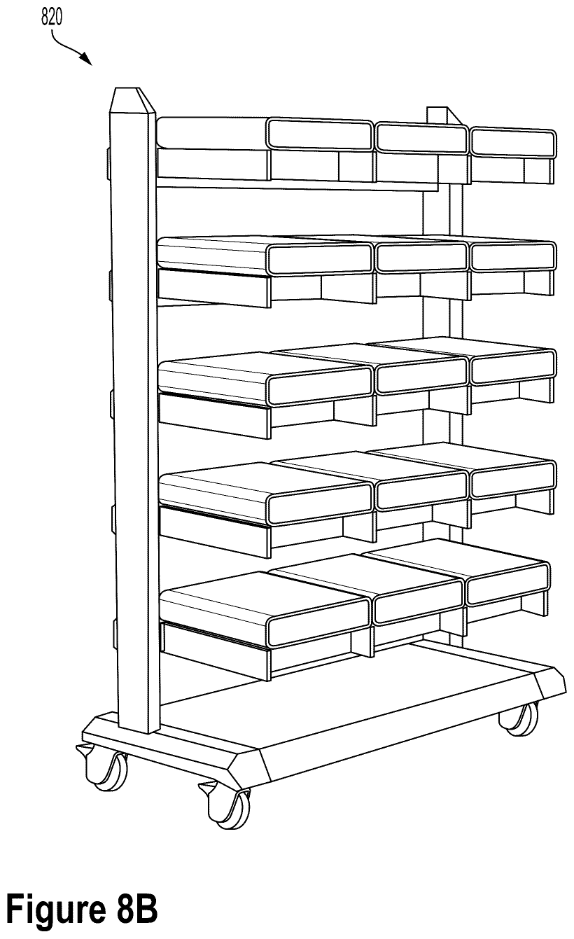

FIG. 8A illustrates a rack-mounted cage system 800, according to an example embodiment. In some examples, the rack-mounted cage system 800 can be similar or identical to rack-mounted cage system 200. In various embodiments, the rack-mounted cage system 800 can include fifteen bays (e.g., bays 208) arranged in a five-by-three array. The bays can correspond to fifteen cage data units (e.g., cage data unit 120) and fifteen cage housings (e.g., cage housing 133). Rack-mounted cage systems with more or fewer bays and/or cage data units and/or cage housings are possible and contemplated. As described above, the rack-mounted cage system 800 can include various shared resources such as a power supply (e.g., power supply 212), environmental monitoring unit (e.g., environmental monitoring unit 216) and/or a shared air handling unit (e.g., shared tower blower or house air 210).

FIG. 8B illustrates a rack-mounted cage system 820, according to an example embodiment.

### III. Example Methods

The digital biomarker development process is a complex and multifaceted endeavor that requires the collaboration of cross-functional teams. To facilitate this collaboration, the present disclosure describes a suite of tools that have been developed to enable sharing of studies both within and external to the organizations. These tools also provide access to video and metrics through export features within the application. The Kubernetes-based Data Science Workspace provides a secure and scalable environment for algorithm development and access to key study data. This suite of tools is designed to streamline the digital biomarker development process and enable teams to work together more effectively.

The Data Science Workspace is an end-to-end system designed to facilitate creation, management, and collaboration of in vivo studies for the development and visualization of digital biomarkers. The system allows users to create and manage studies, define groups (including multiple groups per study), define cages and animals (with many cages per group and up to three animals per cage), and import groups, cages, and animals from Excel files. Users can start and stop recording, manage animals (including marking found dead or euthanized animals and adding or removing animals from cages), and access interactive plots and video. The system currently supports these metrics: movement, locomotion, wheel, food and water occupancy, loss of righting reflex, seizure, gait, rearing, and scratch. Users can visualize metrics for the entire study, restrict the timeline to current day, 24 hours or 7 days with a button click, or zoom in by selecting on the plot. Users can navigate the recorded video from both the top and side camera, select a point on the plot and video snaps to that time, click on the video and expand to full screen view for visualizing details. Users can download 1-min video clips and use them in a presentation or report. In addition, three video options are available: standard, high contrast, or overlay. Overlay shows the segmentation, bounding box, and key points from the machine learning pipeline. Users can export study metrics at the group or cage level as .csv files. Annotations are also supported; users can create comments or notes (@person or #tag to highlight importance), pin video to specific date and time, reply inline to keep communication flowing, and share studies with colleagues internal and external to their organization. Guest users are allowed but can be restricted to have read and annotate access only.

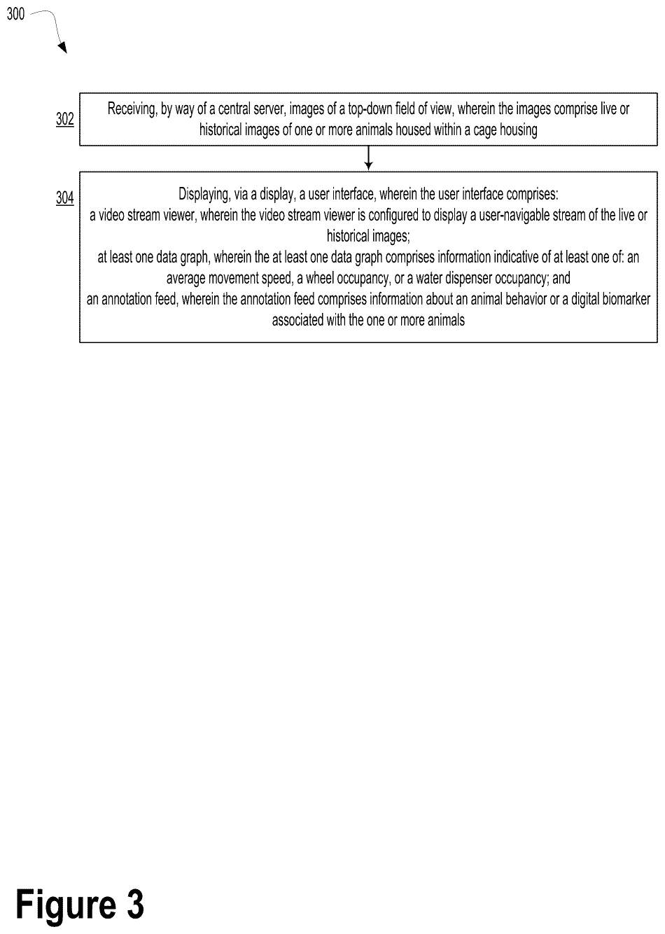

FIG. 3 illustrates a method 300, according to an example embodiment. It will be understood that the method 300 can include fewer or more steps or blocks than those expressly illustrated or otherwise disclosed herein. Furthermore, respective steps or blocks of method 300 can be performed in any order and each step or block can be performed one or more times. In some embodiments, some or all of the blocks or steps of method 300 can be carried out by controller 150, gateway 10, central server 12, and/or other elements of system 100 and/or rack-mounted cage system 200 as illustrated and described in relation to FIGS. 1 and 2.

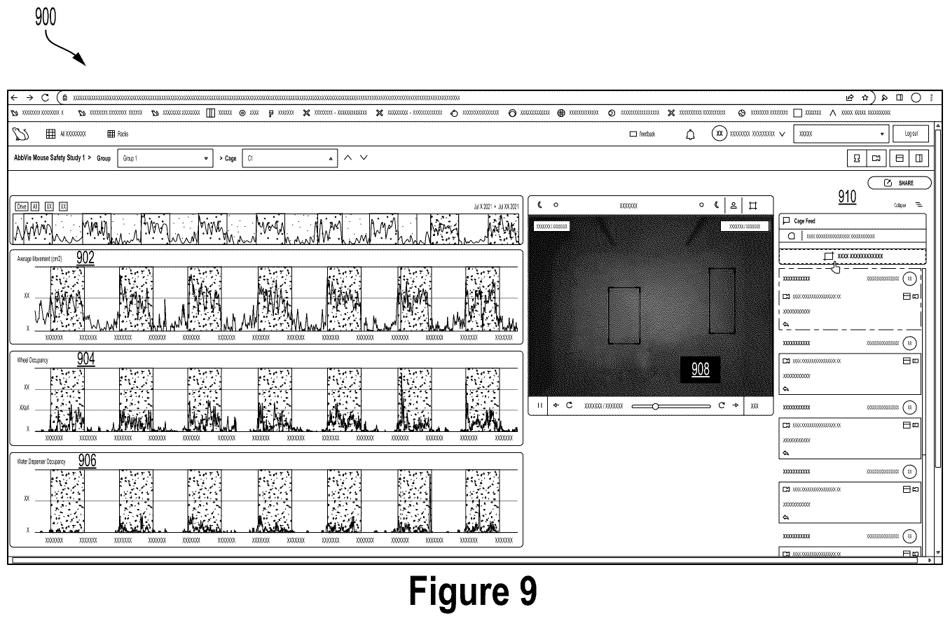

FIG. 9 illustrates a user interface 900, according to an example embodiment. User interface 900 can include various windows or regions. As an example, user interface 900 can include an average movement graph 902, a wheel occupancy graph 904, and a water dispenser occupancy graph 906. Additionally or alternatively, user interface 900 can include a live or historical video stream viewer 908. Yet further, user interface 900 can include a cage feed 910. Block 302 includes receiving, by way of a central server (e.g., central server 12), images (e.g., captured images 126) of a top-down field of view (e.g., top-down field of view 124). In some examples, the images include live or historical images of one or more animals (e.g., animals 132) housed within a cage housing (e.g., cage housing 133).

Block 304 includes displaying, via a display, a user interface (e.g., user interface 180). In some examples, the user interface can include a video stream viewer (e.g., video stream viewer 908). In such scenarios, the video stream viewer can be configured to display a user-navigable stream of the live or historical images.

The user interface can also include at least one data graph. The at least one data graph can include information indicative of at least one of an average movement speed (e.g., average movement graph 902), a wheel occupancy (e.g., wheel occupancy graph 904), or a water dispenser occupancy (e.g., water dispenser occupancy graph 906).

In various examples, the user interface can additionally include an annotation feed (e.g., cage feed 908). In such scenarios, the annotation feed includes information about an animal behavior type or a digital biomarker associated with the one or more animals.

In some embodiments, displaying the user interface can include displaying live or historical information via at least one of the video stream viewer, the at least one data graph, or the annotation feed.

In some examples, method 300 can also include capturing the images using a top-down camera (e.g., top-down camera 122) disposed in a cage data unit (e.g., cage data unit 120) that can be attachable and optically coupled to a cage housing (e.g., cage housing 133).

In example embodiments, method 300 can additionally or alternatively include classifying, at least a portion of the images, using a local computing device (e.g., controller 150) and a trained machine learning model (e.g., trained machine learning model 160), as being associated with at least one animal behavior type from a plurality of behavior types (e.g., animal behavior types 162). In some examples, the plurality of animal behavior types can include at least one of movement, locomotion, wheel, food and water occupancy, loss of righting reflex, seizure, gait, rearing, and scratching.

Yet further, method 300 can also include, in response to classifying at least a portion of the images as being associated with at least one animal behavior type, adding a new annotation indicative of the at least one animal behavior type to the annotation feed with a link to a corresponding video clip.

In some embodiments, the new annotation can include at least one of a free-form comment, a hashtag categorization group, and/or an “at” username reference to a user (e.g., @username).

Additionally, method 300 can also include assigning, to at least a portion of the images, using a local computing device and a trained machine learning model, at least one digital biomarker from a plurality of digital biomarkers (e.g., digital biomarkers 164). In some examples, the plurality of digital biomarkers can include heart rate, respiration rate, size, weight, sleep pattern, physical activity, electrodermal activity (EDA), and skin temperature.

In some examples, method 300 can include determining, using a local computing device and a trained machine learning model, a location of a specific animal in the images. In such scenarios, determining the location of the specific animal can include applying an image segmentation mask to the images so as to recognize the specific animal in the images.

In some embodiments, determining the location of the specific animal can include applying an object detection method. In such scenarios, the object detection method includes at least one of: a thresholding method, an edge detection method, or a clustering method.

In various examples, displaying the user interface can also include displaying, via the video stream viewer, at least one bounding box corresponding with the location of the specific animal.

Method 300 can additional or alternatively include assigning, using the local computing device and the trained machine learning model, an identifier to the specific animal. In such scenarios, the identifier can be based on at least one of an ear tag identifier or a tail tattoo identifier.

Method 300 can also include dynamically tracking, using the local computing device and the trained machine learning model, a location of the specific animal.

Yet further, method 300 can include determining, based on the images, a cage-in status or a cage-out status. In such scenarios, the cage-in status includes the cage housing being in a desired position (e.g., properly arranged within the opening 111). The cage-out status can include the cage housing not being in the desired position. The method 300 can also include displaying, via the user interface, the cage-in status or the cage-out status.

The presently disclosed model accepts a frame in a stream of video and makes predictions about animal (e.g., mice or rat) detections, instance segmentations, key points, and other objects' location such as running wheel, water tubes, and feeding area. The model can process a full minute of 760×1008 video at 30 fps in 30.2 seconds, 60 fps for inference, making it useful for real time collection of multi-animal foundational metrics. Furthermore, the model uses a shared backbone for all of the different tasks, making it useful to separate and run some of the model on-device or on the edge. Video inference treats every incoming frame as independent; thus, inference can be distributed over batches across different timesteps or sources.

A hydra-style model uses a shared backbone as a feature extractor that outputs a pyramid of feature maps that are then fed into different heads responsible for different prediction tasks. The hydra-style model is a type of machine learning (ML) model that is composed of multiple smaller models, each of which is responsible for learning a different aspect of the problem. The smaller models are connected in a way that allows them to share information and collaborate on the task. The entire model is 5.52 million parameters, making it extremely lightweight. For example, the trained model can be efficient in terms of parameter space and/or overall computation bandwidth. For training, each head outputs scalar loss and the total loss is a weighted sum of all the individual tasks' losses. The weights for the final loss are considered tunable hyperparameters.

The hydra model is extremely lightweight, having only 5.52 million parameters to provide instance segmentation, detection, and key point predictions. Therefore, training the model is relatively fast, requiring a single A100 GPU operating for 10-12 hours. The model runs in production and is able to process a one-minute video at 30 fps in around 22 seconds. Each cage in the system outputs 2,592,000 frames every 24 hour period, corresponding to 26 Terapixels per day per cage (at 10 megapixels×2.6 million captures). With no shortage of training data to pick from, embodiments described herein provide a continual learning pipeline that samples from production data selectively based on several criteria. The fact that labeling key points and polygons can be time- and computationally-costly makes this an optimization problem where it is desired to minimize the number of samples while maximizing information gain and distribution expansion for the training data that is fed into the model.

To ensure the features required to reliably and thoroughly identify digital biomarkers from video-generated data can be extracted in real-time on a continuous basis and at a reasonable cost, systems and methods described herein can readily capture high frame rate and high spatial resolution video from a complete home cage environment, along with other potential sensor data streams, and process said video or other data streams through a collection of machine learning models to extract many different digital biomarkers in real time with local (“edge”) computing capability. This system uses (or “leverages”) one or a plurality of high-resolution digital cameras at the level of the cage or a collection of cages, and having in proximity thereto an embedded computing system and a collection of custom machine vision models organized in a hydra framework on said computer.

Beneficial features of this system include that the camera and other sensors are in local proximity to an embedded computing platform running this collection of machine vision models organized in the hydra framework. This arrangement provides cost-effective, efficient, local data collection and processing that thereby minimizes the time and cost of transferring biomarker-related information to cloud storage.

In some embodiments, loss masking can be used to utilize all data even if some tasks are not labeled for batches of data. For example, if some data only had polygons, such information can still be used during training for key points if flagged as missing key point data and masking the key point loss for those instances.

The development of a digitally enabled platform for computer vision-based behavioral monitoring in laboratory animals represents a significant advancement in the field of drug development and other relevant applications. This platform offers several key features and benefits that address the limitations of traditional approaches to behavioral phenotyping and provide a pathway for enhanced research capabilities. The scalability of the platform is one of them. Traditional approaches to behavioral phenotyping often struggle to accommodate complex studies with large numbers of animals. However, this platform offers the capability to scale into a multi-cage stack, enabling researchers to conduct more extensive and detailed investigations. The integrated data science workbench further enhances scalability by providing computational scientists and biostatisticians with a powerful platform to streamline and automate their workflows related to DB and machine learning analysis. This not only increases efficiency but also facilitates collaboration among team members through annotation and study sharing features built into the user interface.

The platform addresses the challenges associated with data sharing and standardization in the pharmaceutical industry. The cloud-based infrastructure permits easy access to the collected data by veterinary professionals and behavioral scientists. The intuitive user interface provides live monitoring and visualization of the digital biomarkers, enabling identification of significant events and behavioral or physiological changes. This promotes collaboration and knowledge sharing across different research teams and even between academia and the pharmaceutical industry. The platform's ability to acquire, store, integrate, and analyze video analytics on a massive scale offers novel insights and facilitates development of clinically relevant biomarkers from in vivo research. The detection head is based on YOLOX, which is an anchor-free, single-stage object detection algorithm. YOLOX uses a decoupled head for classification and regression tasks, removes anchor boxes, and uses a new training strategy called SimOTA, which improves training speed and accuracy. In some examples, the detection head is configured to detect animals such as mice, running wheel, food containers, and water containers.

The segmentation head outputs a feature map that is the same size as the original resolution image, with each pixel being labeled as mouse or no mouse. A decoder is then run as a top-down pathway from the highest level of the pyramid, merging and up-sampling feature maps at each step, up to and including level 3 of the pyramid. The final prediction is obtained by up-sampling the output of the original frame resolution. A challenge then arises when doing multi-animal segmentation where each pixel with a mouse label needs to be individualized. Each pixel in the segmentation map can be assigned to the closest centroid (where the centroid comes from the keypoint head). Since mice are not convex objects, this kind of instance segmentation often failed in prior art systems. For example, the tail of a mouse might be very close to the centroid of another mouse. Furthermore, the boundaries of mice touching each other would be linear. To overcome this, an offset factor and/or another type of adjustment can be added to the model, and it is tasked with computing per-pixel votes of which centroid the model believes the pixel is closest to, and acts as a bias term when computing the nearest centroid of a pixel.

The keypoint head predicts 5 keypoints of interest: left ear, right car, tip of nose, base of tail, and tip of tail. Each keypoint is represented as a 2D isotropic Gaussian whose mean is the keypoint coordinate and variance is a tunable hyperparameter. The decoding step is similar to the segmentation head merging and up-sampling feature maps. More or fewer keypoints are possible and contemplated.

Once the model is trained, the inference step has several sub-tasks to perform, including linking keypoints to individual animals. The first step is using the YOLOX detection head to output a collection of bounding box proposals for animals of interest. At the same time, the segmentation head outputs a proposal of animal vs no-animal per pixel. To obtain instance segmentation (different instance of animal), the model uses the centroids and offsets (where each pixel essentially votes for which centroid it is closest to with its offset vector). Lastly, for each detected animal, all keypoints are associated to the instance by conditioning them to the instance segmentation and box that have already been calculated.

While the model is making live predictions, the system creates a basin of images where, for example, the number of animals detected does not match the number of animals expected in the cage, or where the polygon does not meet certain requirements, or where a number of key points were missed or misplaced. This basin can fill up quite quickly given the number of frames, and selectively sampling from the basin for re-training becomes paramount. To do so, the re-training system uses image embeddings to cluster similar images close to each other and uses stratified sampling in an attempt to sample diverse “miss” cases in a representative manner.

For faster inference, NVIDIA's TensorRT framework can be utilized. In such scenarios, such features can give the inference engine access to dynamic batching and concurrent model execution through NVIDIA's Triton.

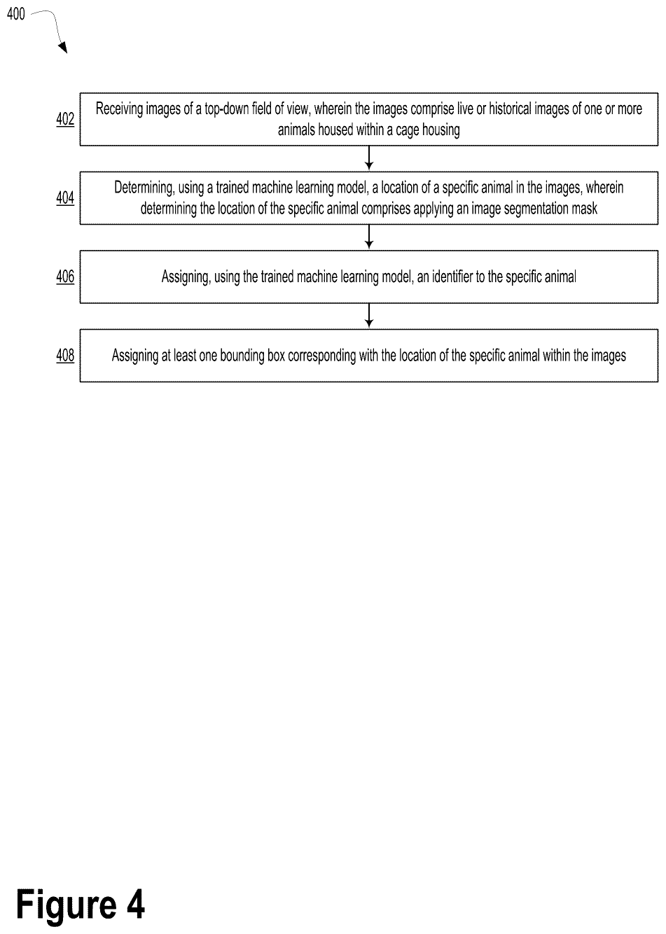

FIG. 4 illustrates a method 400, according to an example embodiment. It will be understood that the method 400 can include fewer or more steps or blocks than those expressly illustrated or otherwise disclosed herein. Furthermore, respective steps or blocks of method 400 can be performed in any order and each step or block can be performed one or more times. In some embodiments, some or all of the blocks or steps of method 400 can be carried out by controller 150, gateway 10, central server 12, and/or other elements of system 100 and/or rack-mounted cage system 200 as illustrated and described in relation to FIGS. 1 and 2.

Block 402 includes receiving images (e.g., captured images 126) of a top-down field of view (e.g., top-down field of view 124). In such scenarios, the images include live or historical images of one or more animals (e.g., animals 132) housed within a cage housing (e.g., cage housing 133).

Block 404 includes determining, using a trained machine learning model (e.g., trained machine learning model 160), a location of a specific animal in the images. In such scenarios, determining the location of the specific animal includes applying an image segmentation mask. In some examples, determining the location of the specific animal can include applying an object detection method. In such scenarios, the object detection method includes at least one of a thresholding method, an edge detection method, or a clustering method.

Block 406 includes assigning, using the trained machine learning model, an identifier to the specific animal. In some examples, the identifier can be based on at least one of: an car tag identifier or a tail tattoo identifier.

Block 408 includes assigning at least one bounding box corresponding with the location of the specific animal within the images.

In some examples, method 400 further includes classifying, at least a portion of the images, using the trained machine learning model, as being associated with at least one animal behavior type from a plurality of animal behavior types (e.g., animal behavior types 162). In some examples, the plurality of animal behavior types include movement, locomotion, wheel, food and water occupancy, loss of righting reflex, seizure, gait, rearing, and scratching.

Method 400 can additionally or alternatively include assigning, to at least a portion of the images, using the trained machine learning model, at least one digital biomarker from a plurality of digital biomarkers (e.g., digital biomarkers 164). In such scenarios, the plurality of digital biomarkers can include heart rate, respiration rate, size, weight, sleep pattern, physical activity, electrodermal activity (EDA), and skin temperature. Additionally or alternatively, the digital biomarkers can include coat condition, eye clarity, presence, absence, condition of lesions, posture, loss of righting reflex, seizure state, seizure type, overall animal health, disease state, scratching, and assessment of activities including marble burying or nest building.

In various embodiments, method 400 can include dynamically tracking, using the trained machine learning model, a location of the specific animal.

In various examples, method 400 can include determining a pose of the animal. In such scenarios, a plurality of key points can be identified and tracked on the target animal. In doing so, conventional object position information can be augmented by object orientation vector information based on prior vector information to provide a likelihood of how the object can be expected to move.

In specific embodiments using as an example a laboratory mouse, such a pose estimation reveals the direction the mouse is facing. Because a mouse in a particular orientation has limited degrees of freedom in which it can change direction, the tracking algorithm can use (or “leverage”) a pose estimation to provide greater accuracy with improved information regarding the animal's movement.

Similar or identical approaches to leveraging pose estimation to improve tracking algorithm accuracy can be applied to other tasks beyond object tracking, such as measures of how the object interacts with other objects in its surrounding environment. For example, in biological research leveraging animal models, the amount of time an animal spends performing particular tasks or activities (such as time spent on a running wheel, at a feeder, at a water sipper, or some other element in the environment) can be quantified. Standard approaches to this problem, which use or leverage object position as in input (in the form of centroids, bounding boxes, and the like) are plagued by false positives due to the possibility that the tracked object is in close proximity to the environmental object without directly engaging with it.

For example, if a tracked mouse is sitting underneath a running wheel, this can create a false positive for the conventional object tracking approach that leverages object positions only.

In contrast, using the means and methods provided herein in a first step, a pose estimate of the tracked individual is extracted and then used as an input to the algorithm measuring its impact with environmental objects in conventional object tracking algorithms. Because there will be a limited set of pose possibilities in which a tracked individual would interact with the environmental object, false positives are reduced and tracking algorithm performance improved. In a specific example, a mouse that is sitting under a running wheel but whose body axis is oriented orthogonal to the running wheel rotation plane would in conventional tracking approaches trigger a false positive, whereas using the pose-estimate based approach provided herein the mouse would be correctly interpreted as not running on the wheel.

These improvements are generally applicable to any moving object having position orientation relevant characteristics. In particular embodiments these means and methods provided herein are applicable to any experimental situation where the direction or orientation of an experimental animal is a relevant factor for whether the animal is interacting with an element in its environment, including other animals, rather than merely being in proximity to them. These means and methods are also applicable to situations where humans are confined to a particularly defined space whose activities are monitored, such as for incarcerated individuals in prisons, and for inanimate objects such as automobiles and particularly for such objects that are autonomously driven (e.g., by computer means rather than human agency).

In some examples, method 400 can include determining, based on the images, a cage-in status or a cage-out status. In such scenarios, the cage-in status can include the cage housing being in a desired position. Conversely, the cage-out status can include the cage housing not being in the desired position.

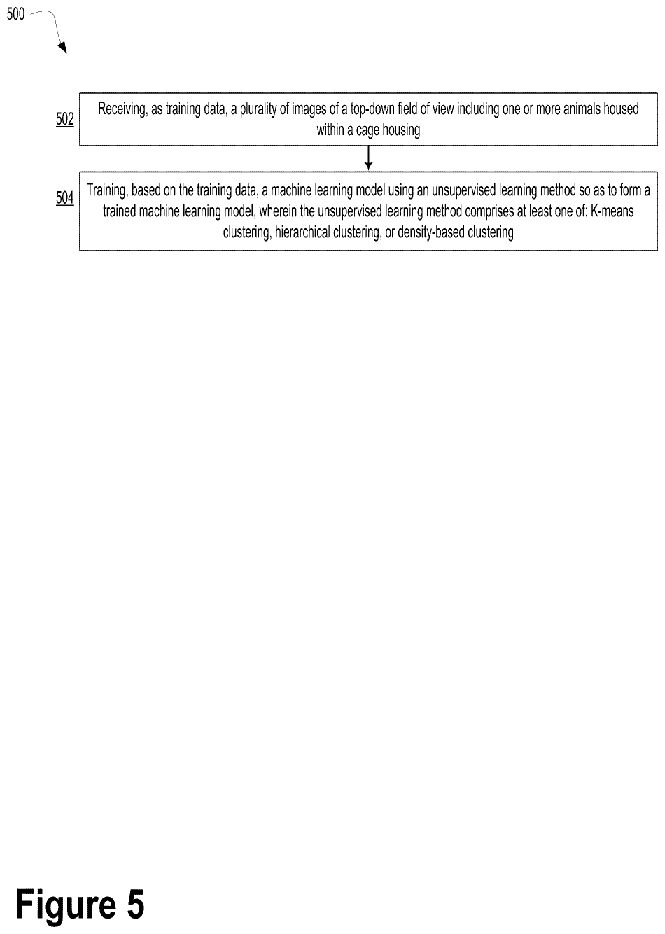

FIG. 5 illustrates a method of training a machine learning model 500, according to an example embodiment. It will be understood that the method 500 can include fewer or more steps or blocks than those expressly illustrated or otherwise disclosed herein. Furthermore, respective steps or blocks of method 500 can be performed in any order and each step or block can be performed one or more times. In some embodiments, some or all of the blocks or steps of method 500 can be carried out by controller 150, gateway 10, central server 12, and/or other elements of system 100 and/or rack-mounted cage system 200 as illustrated and described in relation to FIGS. 1 and 2.

Block 502 includes receiving, as training data, a plurality of images (e.g., captured images 126) of a top-down field of view (e.g., top-down field of view 124) including one or more animals (e.g., animals 132) housed within a cage housing (e.g., cage housing 133).

Block 504 includes training, based on the training data, a machine learning model using an unsupervised learning method so as to form a trained machine learning model (e.g., trained machine learning model 160. In such scenarios, the unsupervised learning method includes at least one of K-means clustering, hierarchical clustering, or density-based clustering.

In various embodiments, method 500 can include identifying, based on the images, at least one specific animal.

Additionally or alternatively, method 500 can include identifying one or more key points associated with a body of the specific animal.

Method 500 can include conducting a trajectory analysis on the specific animal based on a time-dependent location of the one or more key points.

Yet further, method 500 can include, based on the trajectory analysis, determining an estimated future location of the specific animal.

Finally, method 500 can include providing the trajectory analysis as training data for training the machine learning model.

In some example embodiments, method 500 can include providing the trained machine learning model to at least one controller (e.g., controller 150). In such scenarios, the controller can be configured to classify, at runtime, using the trained machine learning model, at least a portion of images captured by a top-down camera (e.g., top-down camera 124) as being associated with at least one animal behavior type from a plurality of animal behavior types (e.g., animal behavior types 162). In such scenarios, the plurality of animal behavior types includes at least one of: movement, locomotion, wheel, food and water occupancy, loss of righting reflex, seizure, gait, rearing, and scratching.

In various examples, the controller can be configured to assign, at runtime, using a trained machine learning model, to at least a portion of images captured by a top-down camera at least one digital biomarker from a plurality of digital biomarkers (e.g., digital biomarkers 164). In such scenarios, the plurality of digital biomarkers can include heart rate, respiration rate, size, weight, sleep pattern, physical activity, electrodermal activity (EDA), and skin temperature. The digital biomarker can additionally or alternatively include coat condition, eye clarity, presence, absence, condition of lesions, posture, loss of righting reflex, seizure state, seizure type, overall animal health, disease state, scratching, and assessment of various activities including marble burying or nest building.

### IV. Further Aspects/Examples

### Multi-Wavelength Focusing

In some example embodiments, a video capture process for dual NIR and visible light imaging is provided. In such scenarios, the process may involve capturing sharp video of subjects positioned at a distance of 25 mm to 250 mm from the lens, ensuring optimal image quality in both Near Infrared (NIR) and visible light spectrums. In some examples, due to the chromatic aberration inherent in the camera lenses, there is a focal plane offset between the NIR and visible light, which must be addressed to achieve clear imaging across both spectrums. In an example, the focusing methodology may take into account chromatic aberration of the optical lenses. Chromatic aberration causes different wavelengths of light to focus at slightly different planes. In some examples, the chromatic aberration in optical lenses causes the NIR focal plane to falls farther from the lens compared to the visible light focal plane. To achieve consistent focus, the described method need not independently adjust the focus for each spectrum. Instead, it can be assumed that the chromatic aberration produces a consistent focal plane offset. By leveraging this phenomena, the optical sharpness can be optimized in the visible and/or NIR spectrum.

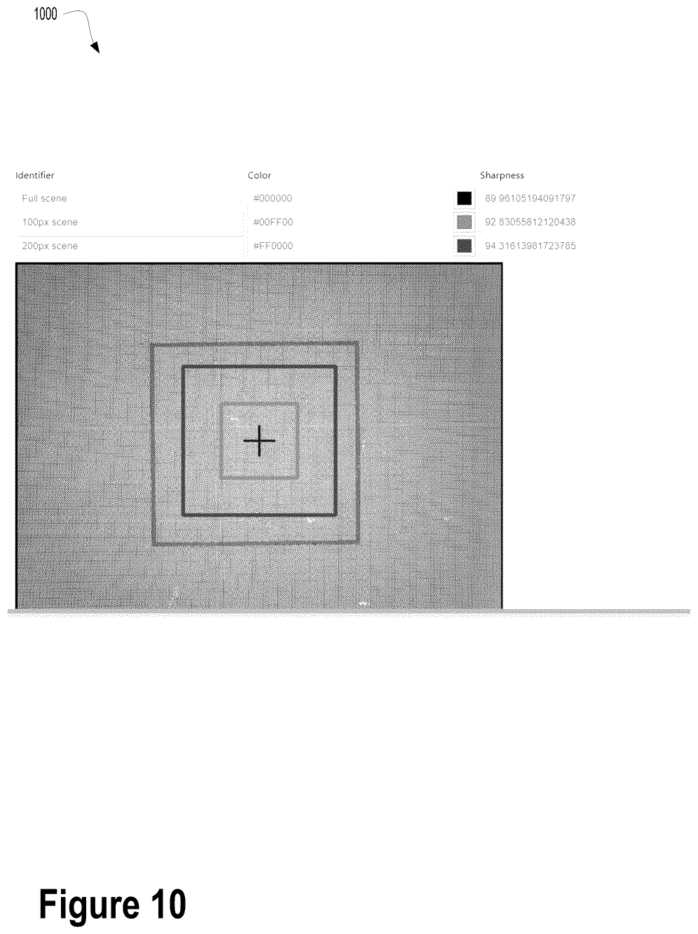

FIG. 10 illustrates a focus grid 1000, according to an example embodiment.

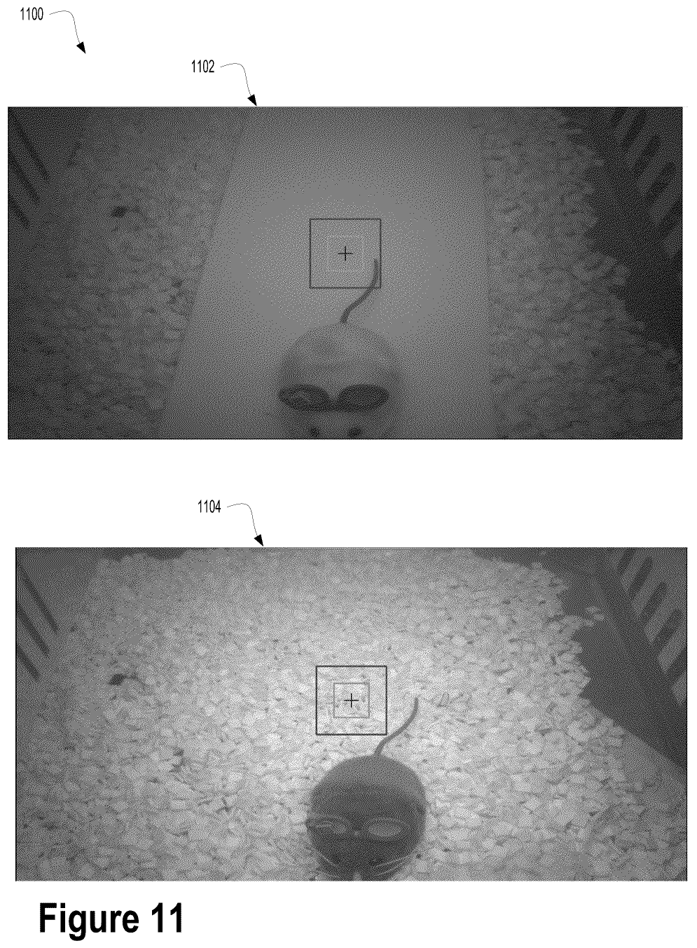

FIG. 11 illustrates images 1100 captured under infrared and visible illumination, according to an example embodiment. Both NIR image 1102 and VIS image 104 were captured using a high offset lens (e.g., oblique angle camera 127 of system 100).

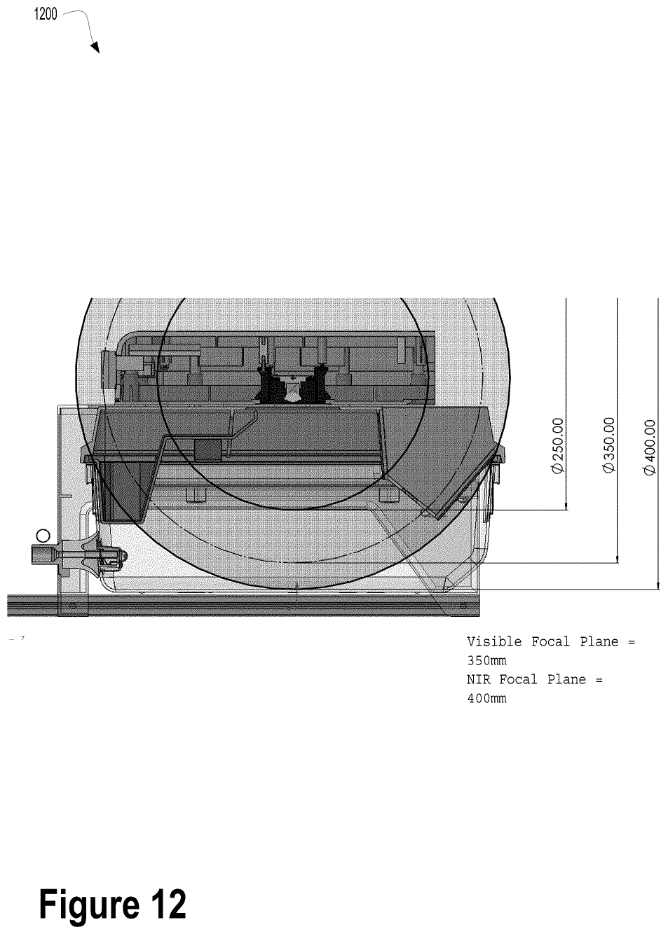

FIG. 12 illustrates a cross-sectional schematic drawing 1200 indicating multiple focal planes based on the illumination wavelength, according to an example embodiment.

In some examples, the focusing process uses a sharpness score derived from a small region of interest on a grid-patterned target. This target allows for an accurate assessment of focus, and the sharpness score can be maximized under visible light conditions. Since the camera sensors are RGB, the focus score is more sensitive and precise in visible light compared to NIR, resulting in a more stable focal point. In various embodiments, an empirical focal plane optimization may be utilized. In such scenarios, an optimal focal plane may be empirically determined by comparing the image quality captured in both NIR and visible light within the target area. By balancing the sharpness across both spectrums, the focal plane is set to achieve the best possible compromise. Due to the offset caused by chromatic aberration, the chosen focal point is generally closer to the lens than the actual target to ensure optimal focus across both spectrums.

### User Interface Workflow

In various example embodiments, systems and methods described herein may involve a user interface (e.g., user interface 180), which may be displayed via a touch screen (e.g., touch screen 182). In some examples, the touch screen could be disposed on a front panel of the cage data unit 120 or another surface of system 100. Alternatively, the touch screen could be disposed adjacent to one or more bays (e.g., bays 208) of a multi-cage rack (e.g., rack 202) so as to be useable whether or not cages are loaded in the bays. In such scenarios, the front panel on the Digital Cage can provide users and/or animal handlers with direct access to various applications and activity tracking functions. An important feature is for the cages to be removable to provide for specific activities such as dosing the animals with drug treatments, weighing the animals, routine blood draws, and other external assays which cannot be conducted from inside the digital cage while loaded into a bay of the rack system.

Several numbered use case examples follow. The examples provide a Primary user “Rachel”, who may be a Research Associate (RA)/Experiment Tech mainly concerned with the day-to-day operation of a cage experiment and managing the animals, including ordering the animals and initiating the study.

### 1. Tracking Cages:

a. Use Case #1—Setup

A study has been approved, the mice have been received, and Rachel is setting up the animals and assigning to groups. From the study protocol she knows this study will have 5 groups of 6 animals each. There will be 10 control animals and the rest will be treated with a new therapeutic. Each group will have 10 cages, 3 animals per cage. Rachel logs into the Digital In Vivo System (DIVS) (e.g., user interface 180) and creates the study with the appropriate groups and assigns animals with correct animal IDs to each group. She then selects the rack in room b25 where the study will run and moves the cages into the rack slots in the software and notes where each cage goes on a piece of paper so she will physically put them in the right place when she goes to the room.

Done with the setup in DIVS, Rachel then prepares 10 physical cage cards that will go on the outside of the cage so she can keep track of which group of animals is in what cage.

Each cage card includes the following:
Study Name
Cage #
Group (cohort) Name, including color code for that group
Number of mice and strain
Main Contact

Rachel places the cards on the cages and places the 3 mice into each cage. She then checks her notes and places the correct cage in the video slot in the appropriate rack. She double checks her work, then goes back to DIVS and selects ‘start recording’ for the study so all cages are recording. When she goes back to the physical rack she can see on each DAX Digital Display the corresponding cage card information.

b. Use Case #2—Cage Move

It is the third day of the study and Rachel needs to weigh each of the animals and take their blood for additional testing. She walks into the vivarium and decides to take the first 5 cages to the procedure room as that is all the cart can hold. When she removes the cage from the rack slot the Digital Display on the DAX changes to ‘cage removed’, then in very large letters the DAX Digital Display displays the Cage #. She takes the cages to the procedure room, does the procedures which take about two hours, and brings the cages back to place them back into the rack. She looks at the physical cage card on the cage and match the cage # to the one being displayed on the DAX and places the correct cage into the correct rack slot. Once the cage is in place the Digital Display on the DAX changes to ‘cage replaced’ and displays the complete cage card information on the Digital Display. She repeats this with the next group of 5 cages.

c. Use Case #3—Cages are Assigned to a Rack Location Prior to the Study Start/Start Recording

In some examples, once a study has been created, the ‘start recording’ button is selected and the cages are assigned to a slot/rack location. If the ‘stop recording’ button is selected, the recording is stopped and the rack location is discontinued. The location needs to be reassigned if the ‘start’ recording is selected to restart recording.

In alternative embodiments, Rachel creates the study, the groups, and the animals. She then assigns cages to a location in a rack (drag and drop). She then physically creates the cage cards, puts the animals in the cages and puts the cages in the rack. Each DAX digital display is displaying the cage number of the cage assigned to that rack. Rachel puts the correct cage into the DAX and confirms Cage 001 is in position 001 in the rack by clicking the button on the display. This synchronizes with the application. Rachel then goes to her office and opens the application and study, and clicks the ‘start recording; button for the study. The digital display on all cages indicates that the recording has started.

d. Use Case #4—Cage Move with Event Prompts

Same scenario as Use case #2, but when the cage is removed from the rack location, the Digital Display changes to ‘cage removed for blood draw-yes, no’ and prompts Rachel to select the purpose for removing the cage. As she removed the cage, she selects ‘yes’ and the Digital Display then changes to display the Cage # as before. This event is the recorded in the study. When Sam the Study Director opens the study in DIVS, he can see that there was a blood draw event completed on day x of the study.

### 2. Alerts/Notifications:

a. Use Case #1

Rachel is in the vivarium retrieving cages to weigh the animals in the study listed above. Another study is also in that rack with 5 cages associated with it. She does an animal wellness check on those cages and notices one animal in cage 9 appears to be listless with a wet coat. She needs to notify the veterinarian to check out this animal, and the study director. She goes to the DAX Digital Display and selects the ‘alert’ icon and the option of ‘animal in distress’. The system has already been setup in DIVS to email the veterinarian responsible for that room, and the study director associated with that study. They will receive an email (or text) with the details of that animal; study ID, rack and cage #, animal ID. Rachel also goes back to her computer, logs into the DIVS, opens that study, navigates to the animal and makes a note on that day to the condition of that animal. When Sam opens the study in DIVS he will see an alert on the study timeline and be able to click on the icon to see the alert and associated note.

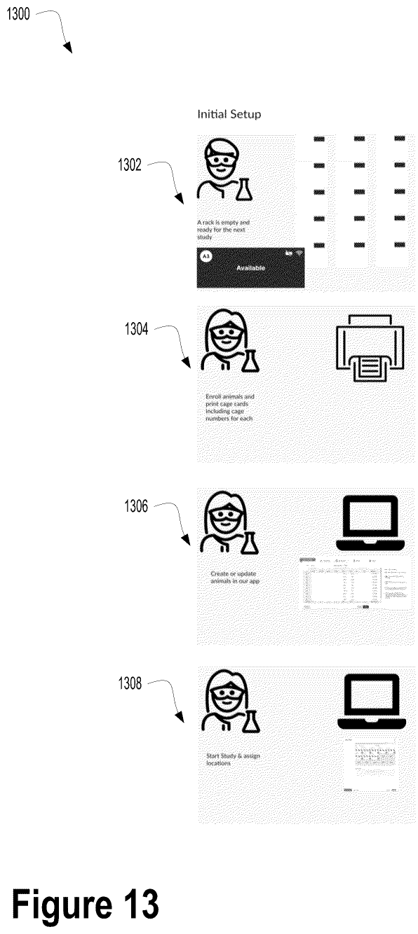

FIG. 13 illustrates several user interface screen shots 1300, according to an example embodiment. Screen shot 1302 shows that all bays are open and available for cage insertion. Screen shot 1304 shows that animals can be enrolled and cage cards can be printed, including cage numbers for each. Screen shot 1306 provides the opportunity to create or update animal entries in the display application. Screen shot 1308 provides a way to start the study and assign cage locations.

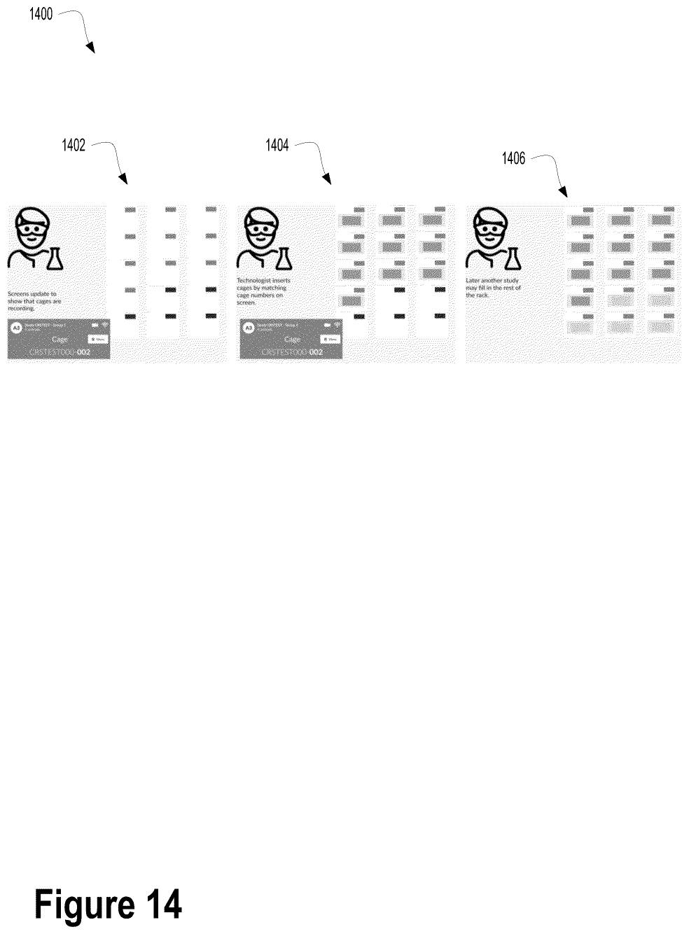

FIG. 14 illustrates several user interface screen shots 1400, according to an example embodiment. Screen shot 1402 provides that the display updates to show that cages can be loaded into respective bays and recording is in progress. Screen shot 1404 provides that a technologist inserts cages by matching cage numbers on the screen. Screen shot 1406 provides that some bays can be utilized at a later time.

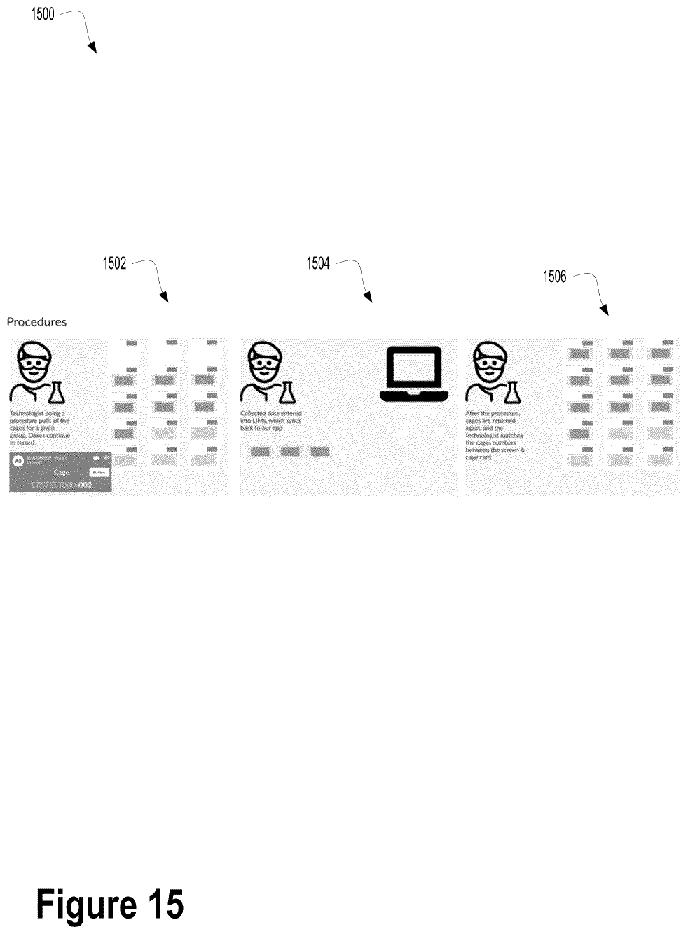

FIG. 15 illustrates several user interface screen shots 1500, according to an example embodiment. Screen shot 1502 provides that a technologist may remove cages associated with a given group. Each digital cage may continue to record. Screen shot 1504 provides that collected data may be automatically synced to the digital display application. Screen shot 1506 provides that after the procedure, cages are returned to the appropriate bays of the rack and the technologist can double-check the cage number and location between the user interface screens and the cage card.

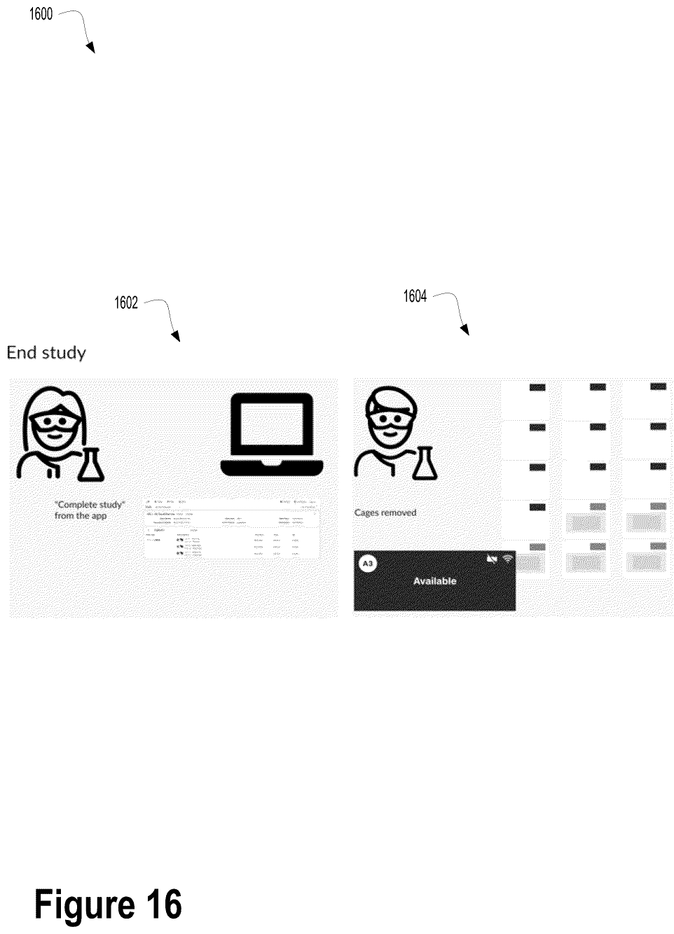

FIG. 16 illustrates several user interface screen shots 1600, according to an example embodiment. Screen shot 1602 provides the option to complete the study. Screen shot 1604 provides status of cages as they are removed from the bays.

In some example embodiments, the default screen on a given touchscreen could identify the bay/rack location, indicate whether the bay is available, whether an associated digital cage is recording, and/or whether the bay is connected via wi-fi or another type of internet connection. In various examples, the background color of the default screen could be blue or another characteristic color to indicate that the cage is available. Once a cage is loaded into the bay, the background color of the default screen could turn green or another color to indicate that the bay is occupied. In some examples, the default screen could indicate how many animals are in a given cage, a cage ID, a study name and/or study group. Various indicators described herein could be presented using icons, symbols, colors, and/or plain text.

In some examples, the user interface could present options for selection by the user. As an example, the user interface could present a button “Animal Dead”. If a user visually confirms that an animal subject has died, the button could be pressed and a database record of animal dead could be made. In some examples, a further menu providing multiple options for the user to indicate which animal of the group had died. In various embodiments, another menu could be presented for the user to select manner of death (e.g., “Found Dead” or “Euthanized”).

In various examples, alarms or other notifications could be provided via the user interface. For example, in the event of a communication network disruption (e.g., loss of wifi), the display could indicate “Lost Gateway Connection” and/or “Lost Internet Access” along with a no-wifi icon.

### Transformer-Based Fine Grained Identification

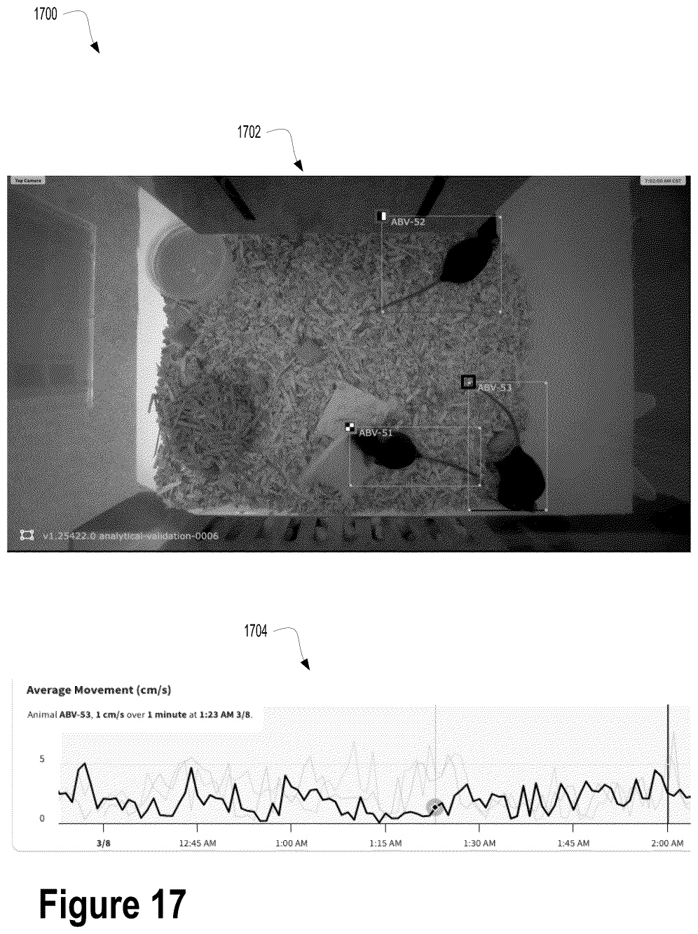

FIG. 17 illustrates an animal tracking and identification scenario 1700, according to an example embodiment. Image 1702 may be obtained from an overhead camera (e.g., top-down camera 122). Image 1702 includes three mice within the cage housing, bedding material, food hopper, and water bottle holder. Overlaid bounding boxes and animal identifiers are provided for each mouse. Graph 1704 illustrates the tracked movements over time of one of the three mice. In such scenarios, various metrics and related behaviors can be attributed to specific animals.

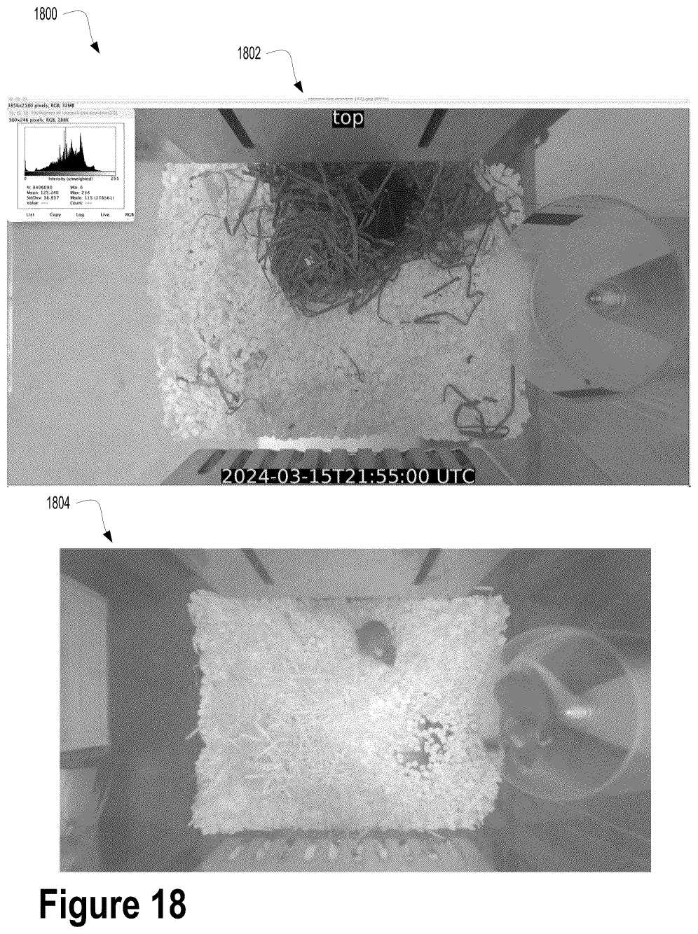

FIG. 18 illustrates a camera initialization/optimization scenario 1800, according to an example embodiment. Image 1802 and 1804 are top-down images that include mice, bedding, and various furniture objects (e.g., exercise wheel, etc.). Camera quality is important to provide high-quality animal identification performance in such images. In some examples, a custom driver could be utilized for operation of the IMX-678 solid state image sensor. Additionally or alternatively, custom firmware could be utilized to tune/optimize image signal processing. In some examples, operations of the camera may involve dynamic switching of image signal processing to deal with different light cycles. In such scenarios, camera settings could be tuned for day-time color accuracy and maximum night luminance. In various examples, image quality metrics could be measured to optimize bitrate and codec performance.

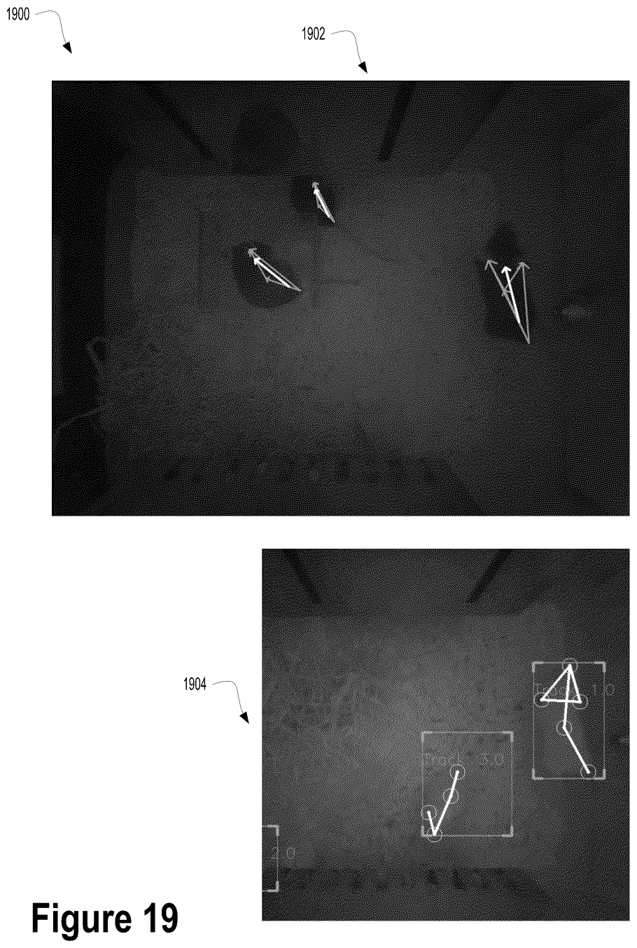

FIG. 19 illustrates an animal tracking scenario 1900, according to an example embodiment. Mice behavior presents challenges to traditional object tracking algorithms. In some examples, an extended Kalman filter (EKF) could be utilized to better handle animal motion. Yet further, in some examples, a custom pose-aware tracking algorithm could be utilized. As an example, a Hungarian algorithm could be used to compare the output of the captured images with ground truth examples of mice and/or other objects. Image 1902 illustrates overlaid vectors associated with three mice that indicate mouse detection and/or pose. In some examples, a tracklet could be determined for each mouse based on a corresponding animal identification and/or pose. Image 1904 illustrates tracklets associated with two mice.

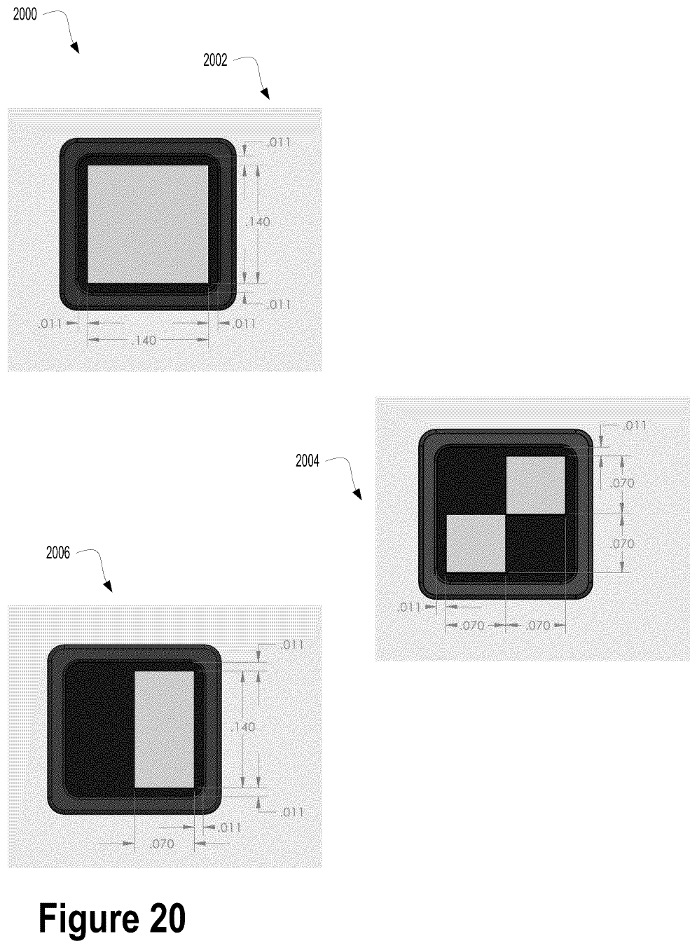

FIG. 20 illustrates several car tags 2000, according to an example embodiment. The car tag 2002 could include an inner white square with a black border. Ear tag 2004 could include a black and white checkerboard pattern with brown border. Ear tag 2006 could include a half black/half white pattern with red border. In some embodiments, RapID cartags could be utilized. Yet further, in various examples, simplified patterns could be utilized for improved computer vision performance. It will be understood that other ear tag patterns, colors, sizes, etc. are possible and contemplated.

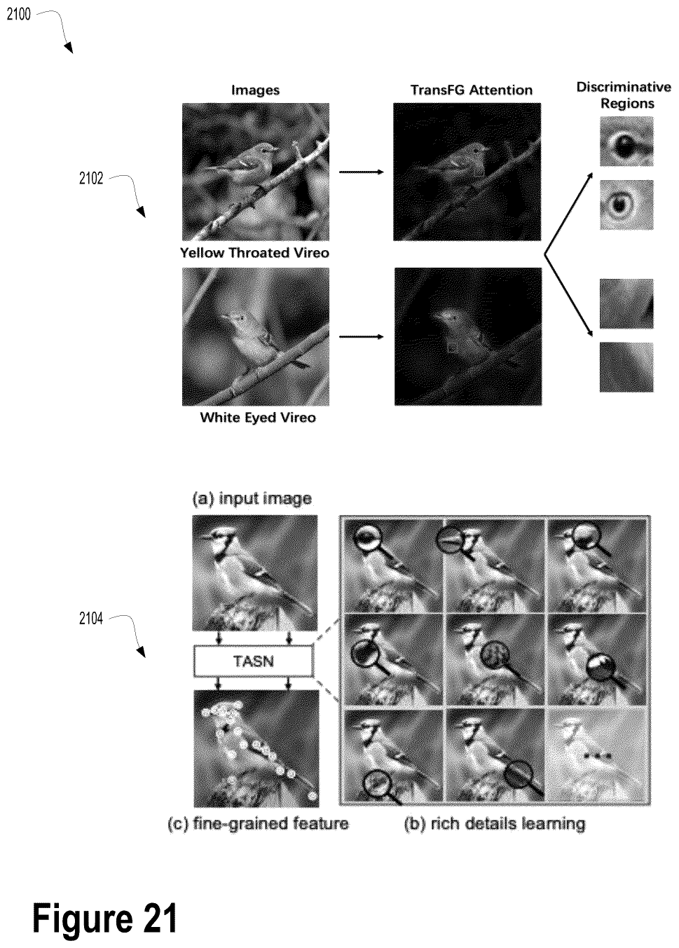

FIG. 21 illustrates an ID classifier scenario 2100, according to an example embodiment. As illustrated in image 2102 an image classifier model could be trained by weighted areas of attention. Such areas could be termed discriminative regions, such as regions around a bird's eyes among other possibilities. In some examples, as shown in image 2104, selected rich details of a given input image could be used to train the object recognition classifier. The mouse identification classifier described herein could be trained in a similar fashion.

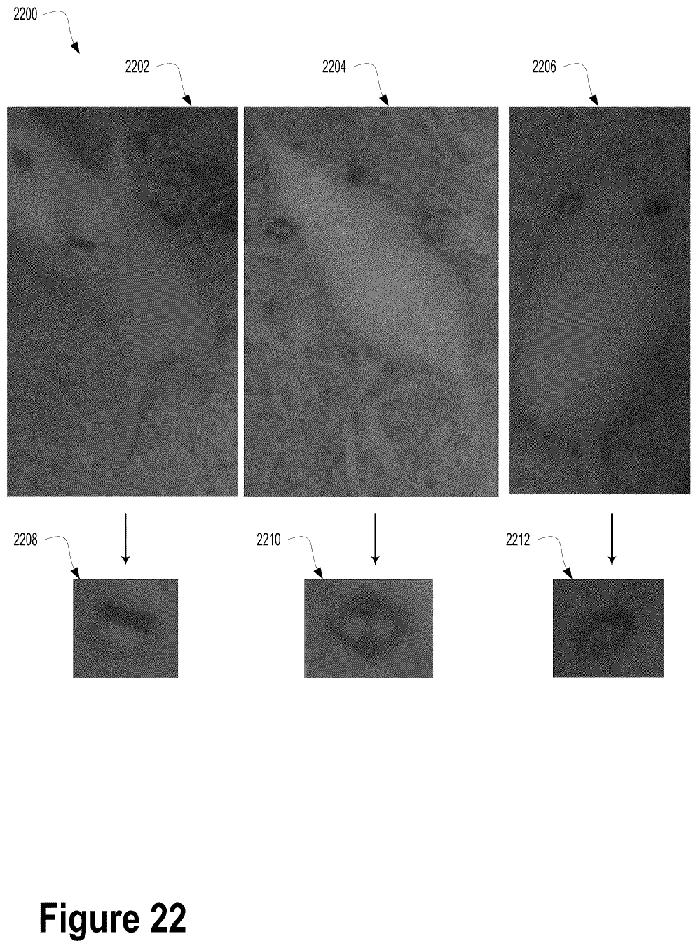

FIG. 22 illustrates an animal identification scenario 2200, according to an example embodiment. The mouse in image 2202 could be recognized by the half-black half-white tag shown in image portion 2208. The mouse in image 2204 could be recognized by the checkerboard pattern tag shown in image portion 2210. The mouse in image 2206 could be recognized by the white center and black border pattern tag shown in image portion 2212.

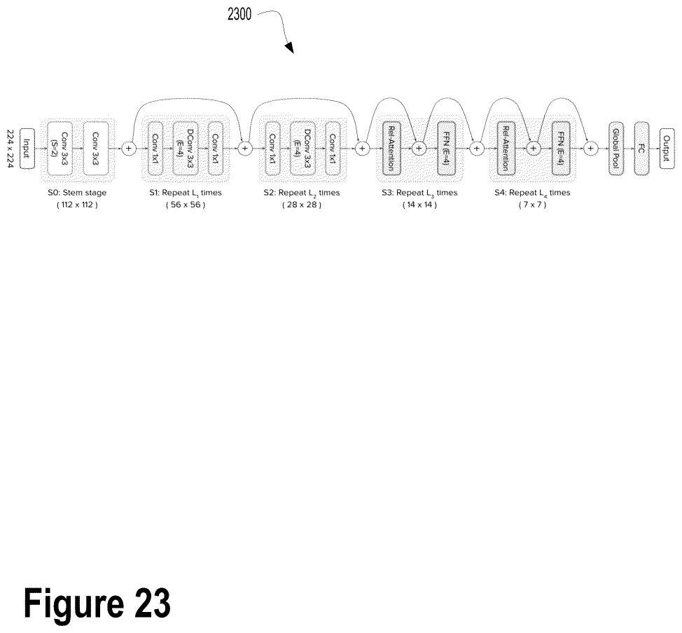

FIG. 23 illustrates a convolutional neural network 2300, according to an example embodiment.

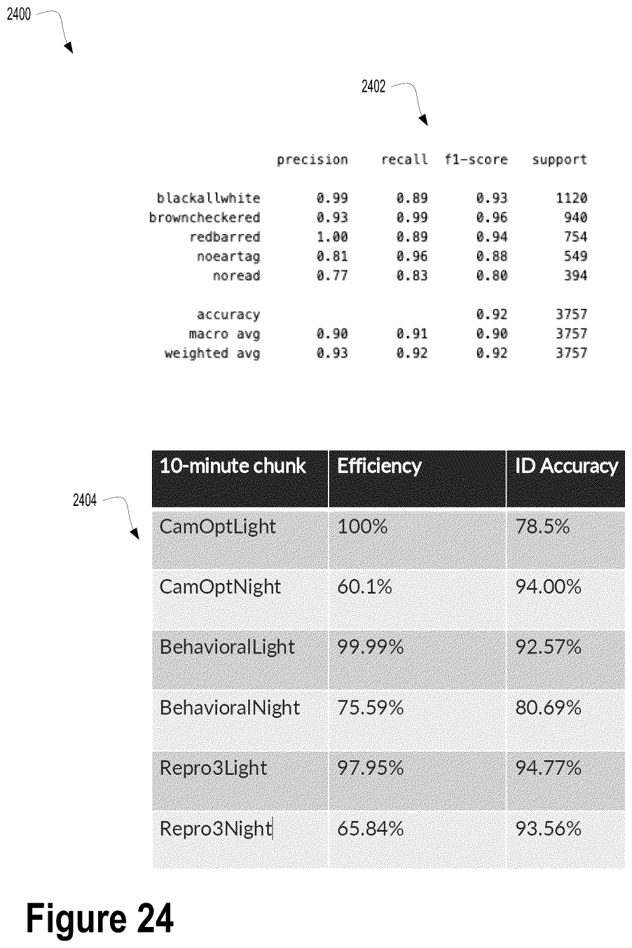

FIG. 24 illustrates results of an animal identification scenario 2400, according to an example embodiment. Table 2402 shows an accuracy of the ID detection model for various tag patterns. Table 2404 indicates the accuracy of the ID detection model under various lighting and behavioral conditions.

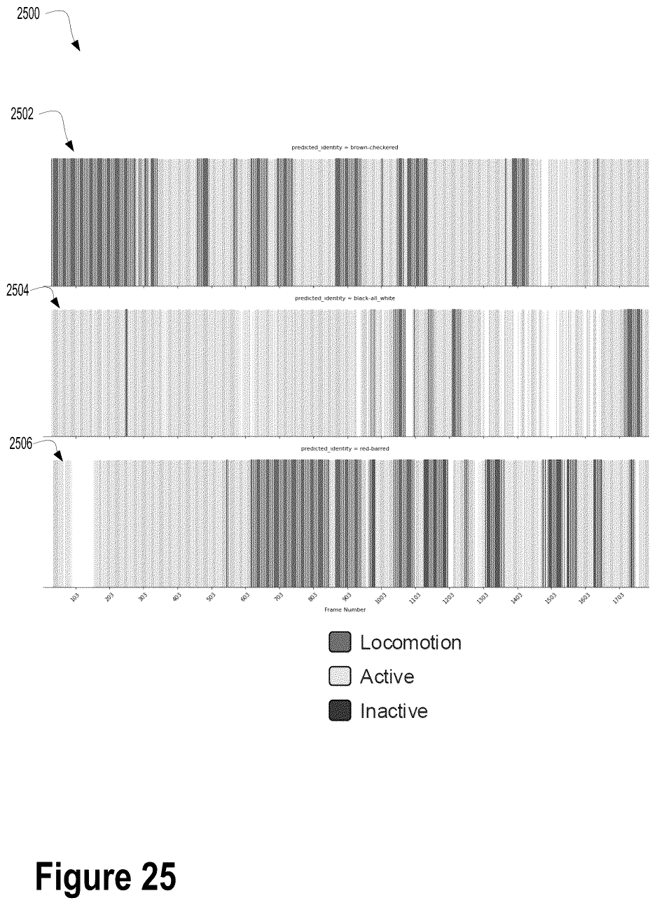

FIG. 25 illustrates an animal activity tracking scenario 2500, according to an example embodiment. Graph 2502 indicates the detected activity as a function of time for Animal 1. Graph 2504 indicates the detected activity as a function of time for Animal 2. Graph 2506 indicates the detected activity as a function of time for Animal 3. The various colors indicate different behaviors. Red indicates inactivity, yellow indicates activity, and green indicates locomotion.

### V. Enumerated Example Embodiments (EEE)

In this section, various example embodiments of the invention are presented. These embodiments are provided to illustrate the versatility and adaptability of the invention in different contexts and scenarios. It is important to note that these examples are not intended to limit the scope of the invention; rather, they are provided to give a clearer understanding of the invention and its potential applications. Each embodiment described herein includes specific details and configurations, but it is understood that these embodiments can be modified or adjusted without departing from the core principles and novel features of the invention.

EEE 1 is a system comprising:
a cage housing comprising:
   a cage top; and
   a cage bottom;
a cage data unit;
   a top-down camera configured to capture images of a top-down field of view including one or more animals housed within the cage housing; and
   an illumination module configured to illuminate the top-down field of view;
an air handling system coupled to the cage housing; and
a controller operable to carry out operations, the operations comprising causing the top-down camera to capture images of the top-down field of view.

EEE 2 is the system of EEE 1, wherein the operations further comprise:
identifying from at least a portion of the captured images, using a trained machine learning model, the one or more animals.

EEE 3 is the system of EEE 2, wherein the operations further comprise:
assigning a bounding box based on a respective identified animal.

EEE 4 is the system of EEE 3, wherein the operations further comprise:
determining a centroid of the bounding box.

EEE 5 is the system of EEE 4, wherein the operations further comprise:
determining a segmentation mask within the bounding box.

EEE 6 is the system of EEE 5, wherein the operations further comprise:
determining a plurality of keypoints on a respective identified animal.

EEE 7 is the system of EEE 1, wherein the operations further comprise:
classifying at least a portion of the captured images, using a trained machine learning model, as being associated with at least one animal behavior type from a plurality of animal behavior types, wherein the plurality of animal behavior types comprises: movement, locomotion, wheel, food and water occupancy, loss of righting reflex, seizure, gait, rearing, and scratching.

EEE 8 is the system of EEE 1, wherein the operations further comprise:
assigning, to at least a portion of the captured images, using a trained machine learning model, at least one digital biomarker from a plurality of digital biomarkers, wherein the plurality of digital biomarkers comprises: heart rate, respiration rate, size, weight, sleep pattern, physical activity, electrodermal activity (EDA), skin temperature, coat condition, eye clarity, presence, absence, condition of lesions, posture, loss of righting reflex, seizure state, seizure type, overall animal health, disease state, scratching, and assessment of activities including marble burying or nest building.

EEE 9 is the system of EEE 1, wherein the controller comprises:
a graphics processor unit (GPU);
a central processor unit (CPU); and
a memory, wherein the GPU, the CPU, and the memory are coupled to a shared substrate, wherein the controller is configured to perform machine learning tasks.

EEE 10 is the system of EEE 9, wherein the controller comprises an NVIDIA Jetson Nano series module.

EEE 11 is the system of EEE 1, wherein the illumination module comprises:
a plurality of infrared light sources;
a plurality of visible light sources; and
a light diffuser disposed along a downward-facing surface of the housing.

EEE 12 is the system of EEE 11, wherein the plurality of infrared light sources and the plurality of visible light sources are disposed in an interleaved arrangement, wherein the interleaved arrangement is selected so as to evenly illuminate the cage bottom with visible light or infrared light.

EEE 13 is the system of EEE 11, wherein the plurality of infrared light sources are configured to emit infrared light having a wavelength of at least 900 nm.

EEE 14 is the system of EEE 1, wherein the top-down camera is configured to capture images at Ultra High Definition (UHD) 4K (4032×3040 pixels) resolution at 30 frames per second.

EEE 15 is the system of EEE 1, wherein the cage housing further comprises:
a food hopper; and
a water bottle holder.

EEE 16 is the system of EEE 15, wherein at least one of the food hopper or the water bottle holder is shaped to so as to reduce occluding the top-down field of view.

EEE 17 is the system of EEE 1, wherein the cage top comprises:
a static vent along a front surface of the cage top, where the static vent is air permeable.

EEE 18 is the system of EEE 1, wherein the air handling system comprises:
at least one fan;
a HEPA filter;
one or more airflow connectors; and
a vibration isolation mechanism.

EEE 19 is the system of EEE 18, wherein the air handling system further comprises a PID controller, wherein the PID controller is configured to control the at least one fan to provide a constant pressure or constant flowrate to the cage housing when attached.

EEE 20 is the system of EEE 18, wherein the vibration isolation mechanism comprises a plurality of spring elements that couple the at least one fan to the housing, wherein the plurality of spring elements are configured to dampen vibrations caused by operation of the at least one fan.

EEE 21 is the system of EEE 18, wherein the cage housing further comprises a plurality of airflow connectors disposed along a rear surface of the cage top, wherein airflow connectors are configured to attachably couple to the air handling system when the cage housing is mounted within the housing.

EEE 22 is the system of EEE 1, further comprising a communication interface, wherein the communication interface communicatively couples the controller to at least one of: a gateway or a central server.

EEE 23 is the system of EEE 1, wherein the cage data unit further comprises an oblique angle camera, wherein the oblique angle camera is configured to capture images of an oblique angle field of view.

EEE 24 is the system of EEE 23, wherein the oblique angle camera is configured to capture images at 2K (2560×1440 pixels) resolution at 30 frames per second.

EEE 25 is the system of EEE 1, further comprising a user interface, wherein the user interface comprises a touch screen disposed along a front surface of the housing.

EEE 26 is the system of EEE 25, wherein the operations further include:
in response to receiving a user command via the touch screen, adjusting at least one operational aspect of the system.

EEE 27 is the system of EEE 1, further comprising at least one furniture object within the cage bottom, wherein the furniture object comprises at least one of: a running wheel, a rotowheel, a rotobar, or a ladder.

EEE 28 is the system of EEE 1, wherein the housing further comprises a light sensor, wherein the light sensor is configured to provide information indicative of an ambient light level to the controller, wherein the operations of the controller further comprise:
adjusting an exposure setting of the top-down camera based on the ambient light level; or
adjusting an acquisition mode of the top-down camera based on the ambient light level.

EEE 29 is the system of EEE 1, wherein the cage bottom is configured to attachably couple to the cage top, wherein the cage bottom is sized in compliance with European Directive 2010/63/EU.

EEE 30 is the system of EEE 1, wherein the cage bottom comprises a clear plastic material, wherein the clear plastic material comprises polyethylene terephthalate glycol (PETG), wherein the cage bottom includes at least 80 in2 of floor space, wherein sidewalls of the cage bottom are at least 5 inches high.

EEE 31 is the system of EEE 1, wherein the cage bottom comprises a bedding material, wherein the bedding material comprises at least one of: paper bedding, wood shavings, corncob, or cellulose-based paper.

EEE 32 is the system of EEE 1, wherein the one or more animals comprise: one or more mice or rats.

EEE 33 is a rack-mounted cage system comprising:
a base frame;
a plurality of vertical members coupled to the base frame; and
a plurality of bays formed by spaces between the plurality of vertical members, wherein at least a portion of the plurality of bays comprises:
a cage housing comprising:
   a cage top; and
   a cage bottom;
a cage data unit comprising:
   a top-down camera configured to capture images of a top-down field of view including one or more animals housed within the cage housing; and
   an illumination module configured to illuminate the top-down field of view;
an air handling system coupled to the cage housing; and
a controller operable to carry out operations, the operations comprising:
causing the top-down camera to capture images of the top-down field of view.

EEE 34 is the rack-mounted cage system of EEE 33, wherein the operations further comprise:
identifying from at least a portion of the captured images, using a trained machine learning model, the one or more animals.

EEE 35 is the rack-mounted cage system of EEE 34, wherein the operations further comprise:
assigning a bounding box based on a respective identified animal.

EEE 36 is the rack-mounted cage system of EEE 35, wherein the operations further comprise:
determining a centroid of the bounding box.

EEE 37 is the rack-mounted cage system of EEE 36, wherein the operations further comprise:
determining a segmentation mask within the bounding box.

EEE 38 is the rack-mounted cage system of EEE 37, wherein the operations further comprise:
determining a plurality of keypoints on a respective identified animal.

EEE 39 is the rack-mounted cage system of EEE 33, wherein the operations further comprise:
classifying at least a portion of the captured images, using a trained machine learning model, as being associated with at least one animal behavior type from a plurality of behavior types, wherein the plurality of animal behavior types comprises: movement, locomotion, wheel, food and water occupancy, loss of righting reflex, seizure, gait, rearing, and scratching.

EEE 40 is the rack-mounted cage system of EEE 33, wherein the operations further comprise:
assigning, to at least a portion of the captured images, using a trained machine learning model, at least one digital biomarker from a plurality of digital biomarkers, wherein the plurality of digital biomarkers comprises: heart rate, respiration rate, size, weight, sleep pattern, physical activity, electrodermal activity (EDA), skin temperature, coat condition, eye clarity, presence, absence, condition of lesions, posture, loss of righting reflex, seizure state, seizure type, overall animal health, disease state, scratching, and assessment of activities including marble burying or nest building.

EEE 41 is the rack-mounted cage system of EEE 33, wherein the controller comprises:
a graphics processor unit (GPU);
a central processor unit (CPU); and
a memory, wherein the GPU, the CPU, and the memory are coupled to a shared substrate.

EEE 42 is the rack-mounted cage system of EEE 41, wherein the respective air handling systems of each bay are configured to cool the controller.

EEE 43 is the rack-mounted cage system of EEE 33, wherein the respective air handling systems of each bay are coupled to a shared tower blower unit or house air.

EEE 44 is the rack-mounted cage system of EEE 33, further comprising a power supply, wherein at least a portion of the bays are configured to receive electrical power via the power supply.

EEE 45 is the rack-mounted cage system of EEE 33, wherein at least a portion of the bays are configured to accommodate a drawer, a shelf, or an environmental monitoring unit.

EEE 46 is the rack-mounted cage system of EEE 33, further comprising:
a cage identifier, wherein the cage identifier comprises at least one of: a bar code, QR code, an encoded pattern, or another type of visible or infrared identifier or symbol, wherein the cage identifier provides information corresponding to a given cage housing.

EEE 47 is the rack-mounted cage system of EEE 46, wherein the cage identifier is provided by way of at least one of: being etched into the plastic, being affixed with a sticker, or being printed on a backside of a cage card.

EEE 48 is the rack-mounted cage system of EEE 46, further comprising:
a visual identification module, configured to determine the cage identifier based on one or more images captured by at least one of the cameras.

EEE 49 includes a method comprising:
receiving, by way of a central server, images of a top-down field of view, wherein the images comprise live or historical images of one or more animals housed within a cage housing; and
displaying, via a display, a user interface, wherein the user interface comprises:
a video stream viewer, wherein the video stream viewer is configured to display a user-navigable stream of the live or historical images; and
at least one data graph.

EEE 50 includes the method of EEE 49, wherein the at least one data graph comprises information indicative of at least one of: an average movement speed, a wheel occupancy, or a water dispenser occupancy.

EEE 51 includes the method of EEE 49, wherein the user interface further comprises an annotation feed, wherein the annotation feed comprises information about an animal behavior type or a digital biomarker associated with the one or more animals.

EEE 52 is the method of EEE 49, further comprising:
capturing the images using a top-down camera disposed in a cage data unit that is attachable to the cage housing.

EEE 53 is the method of EEE 49, wherein displaying the user interface comprises displaying live or historical information via at least one of: the video stream viewer, the at least one data graph, or the annotation feed.

EEE 54 is the method of EEE 49, further comprising:
classifying, at least a portion of the images, using a local computing device and a trained machine learning model, as being associated with at least one animal behavior type from a plurality of behavior types, wherein the plurality of animal behavior types comprises: movement, locomotion, wheel, food and water occupancy, loss of righting reflex, seizure, gait, rearing, and scratching.

EEE 55 is the method of EEE 54, further comprising:
in response to classifying at least a portion of the images as being associated with at least one animal behavior type, adding a new annotation indicative of the at least one animal behavior type to the annotation feed with a link to a corresponding video clip.

EEE 56 is the method of EEE 55, wherein the new annotation comprises at least one of: a free-form comment, a hashtag categorization group, or an “at” username reference to a user.

EEE 57 is the method of EEE 49, further comprising:
assigning, to at least a portion of the images, using a local computing device and a trained machine learning model, at least one digital biomarker from a plurality of digital biomarkers, wherein the plurality of digital biomarkers comprises: heart rate, respiration rate, size, weight, sleep pattern, physical activity, electrodermal activity (EDA), and skin temperature.

EEE 58 is the method of EEE 49, further comprising:
determining, using a local computing device and a trained machine learning model, a location of a specific animal in the images.

EEE 59 is the method of EEE 58, wherein determining the location of the specific animal comprises applying an image segmentation mask to the images so as to recognize the specific animal in the images.

EEE 60 is the method of EEE 58, wherein determining the location of the specific animal comprises applying an object detection method, wherein the object detection method comprises at least one of: a thresholding method, an edge detection method, or a clustering method.

EEE 61 is the method of EEE 58, wherein displaying the user interface also comprises displaying, via the video stream viewer, at least one bounding box corresponding with the location of the specific animal.

EEE 62 is the method of EEE 58, further comprising:
assigning, using the local computing device and the trained machine learning model, an identifier to the specific animal.

EEE 63 is the method of EEE 62, wherein the identifier is based on at least one of: an ear tag identifier or a tail tattoo identifier.

EEE 64 is the method of EEE 58, further comprising:
dynamically tracking, using the local computing device and the trained machine learning model, a location of the specific animal.

EEE 65 is the method of EEE 49, further comprising:
determining, based on the images, a cage-in status or a cage-out status, wherein the cage-in status comprises the cage housing being in a desired position, wherein the cage-out status comprises the cage housing not being in the desired position; and displaying, via the user interface, the cage-in status or the cage-out status.

EEE 66 is a method comprising:
receiving images of a top-down field of view, wherein the images comprise live or historical images of one or more animals housed within a cage housing;
determining, using a trained machine learning model, a location of a specific animal in the images, wherein determining the location of the specific animal comprises applying an image segmentation mask;
assigning, using the trained machine learning model, an identifier to the specific animal; and
assigning at least one bounding box corresponding with the location of the specific animal within the images.

EEE 67 is the method of EEE 66, further comprising:
assigning at least one bounding box corresponding with the location of the specific animal within the images.

EEE 68 is the method of EEE 66, further comprising:
classifying, at least a portion of the images, using the trained machine learning model, as being associated with at least one animal behavior type from a plurality of behavior types, wherein the plurality of animal behavior types comprises: movement, locomotion, wheel, food and water occupancy, loss of righting reflex, seizure, gait, rearing, and scratching.

EEE 69 is the method of EEE 66, further comprising:
assigning, to at least a portion of the images, using the trained machine learning model, at least one digital biomarker from a plurality of digital biomarkers, wherein the plurality of digital biomarkers comprises: heart rate, respiration rate, size, weight, sleep pattern, physical activity, electrodermal activity (EDA), skin temperature, coat condition, eye clarity, presence, absence, condition of lesions, posture, loss of righting reflex, seizure state, seizure type, overall animal health, disease state, scratching, and assessment of activities including marble burying or nest building.

EEE 70 is the method of EEE 66, wherein determining the location of the specific animal comprises applying an object detection method, wherein the object detection method comprises at least one of: a thresholding method, an edge detection method, or a clustering method.

EEE 71 is the method of EEE 66, wherein the identifier is based on at least one of: an ear tag identifier or a tail tattoo identifier.

EEE 72 is the method of EEE 66, further comprising:
dynamically tracking, using the trained machine learning model, a location of the specific animal.

EEE 73 is the method of EEE 66, further comprising:
estimating a pose of the specific animal, wherein estimating the pose comprises determining a direction the specific animal is facing.

EEE 74 is the method of EEE 66, further comprising:
determining a facing direction of the specific animal with respect to at least one other object within the cage housing; and
determining that the specific animal is interacting with the at least one other object based on the facing direction.

EEE 75 is the method of EEE 66, further comprising:
determining, based on the images, a cage-in status or a cage-out status, wherein the cage-in status comprises the cage housing being in a desired position, wherein the cage-out status comprises the cage housing not being in the desired position.

EEE 76 is a method of training a machine learning model, the method comprising:
receiving, as training data, a plurality of images of a top-down field of view including one or more animals housed within a cage housing; and
training, based on the training data, a machine learning model using an unsupervised learning method so as to form a trained machine learning model, wherein the unsupervised learning method comprises at least one of: K-means clustering, hierarchical clustering, or density-based clustering.

EEE 77 is the method of EEE 76, further comprising:
identifying, based on the images, at least one specific animal;
identifying one or more key points associated with a body of the specific animal;
conducting a trajectory analysis on the specific animal based on a time-dependent location of the one or more key points;
based on the trajectory analysis, determining an estimated future location of the specific animal; and
providing the trajectory analysis as training data for training the machine learning model.

EEE 78 is the method of EEE 76, further comprising:
providing the trained machine learning model to at least one controller configured to:
classify, at runtime, using the trained machine learning model, at least a portion of images captured by a top-down camera as being associated with at least one animal behavior type from a plurality of behavior types, wherein the plurality of animal behavior types comprises: movement, locomotion, wheel, food and water occupancy, loss of righting reflex, seizure, gait, rearing, and scratching.

EEE 79 is the method of EEE 76, further comprising:
providing the trained machine learning model to at least one controller configured to:
assigning, at runtime, using a trained machine learning model, to at least a portion of images captured by a top-down camera at least one digital biomarker from a plurality of digital biomarkers, wherein the plurality of digital biomarkers comprises: heart rate, respiration rate, size, weight, sleep pattern, physical activity, electrodermal activity (EDA), skin temperature, coat condition, eye clarity, presence, absence, condition of lesions, posture, loss of righting reflex, seizure state, seizure type, overall animal health, disease state, scratching, and assessment of activities including marble burying or nest building.

### VI. Conclusion

The above detailed description describes various features and functions of the disclosed systems, devices, and methods with reference to the accompanying figures. In the figures, similar symbols typically identify similar components, unless context indicates otherwise. The illustrative embodiments described in the detailed description, figures, and claims are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flowcharts in the figures and as discussed herein, each step, block and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including in substantially concurrent or in reverse order, depending on the functionality involved. Further, more or fewer steps, blocks and/or functions can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer-readable medium, such as a storage device, including a disk drive, a hard drive, or other storage media.

The computer-readable medium can also include non-transitory computer-readable media such as computer-readable media that stores data for short periods of time like register memory, processor cache, and/or random-access memory (RAM). The computer-readable media can also include non-transitory computer-readable media that stores program code and/or data for longer periods of time, such as secondary or persistent long-term storage, like read only memory (ROM), optical or magnetic disks, and/or compact-disc read only memory (CD-ROM), for example. The computer-readable media can also be any other volatile or non-volatile storage systems. A computer-readable medium can be considered a computer-readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

We claim:

1. A system comprising:
a cage housing comprising:
a cage top; and
a cage bottom;
a cage data unit comprising:
a top-down camera configured to capture images of a top-down field of view including one or more animals housed within the cage housing; and
an illumination module configured to illuminate the top-down field of view;
an air handling system coupled to the cage housing; and
a controller operable to carry out operations, the operations comprising:
causing the top-down camera to capture images of the top-down field of view.

2. The system of claim 1, wherein the operations further comprise one or more of:
identifying from at least a portion of the captured images, using a trained machine learning model, the one or more animals;
assigning a bounding box based on a respective identified animal;
determining a centroid of the bounding box;
determining a segmentation mask within the bounding box; or
determining a plurality of keypoints on a respective identified animal.

3. The system of claim 1, wherein the operations further comprise:
classifying at least a portion of the captured images, using a trained machine learning model, as being associated with at least one animal behavior type from a plurality of animal behavior types, wherein the plurality of animal behavior types comprises: movement, locomotion, wheel, food and water occupancy, loss of righting reflex, seizure, gait, rearing, and scratching.

4. The system of claim 1, wherein the operations further comprise:
assigning, to at least a portion of the captured images, using a trained machine learning model, at least one digital biomarker from a plurality of digital biomarkers, wherein the plurality of digital biomarkers comprises: heart rate, respiration rate, size, weight, sleep pattern, physical activity, electrodermal activity (EDA), skin temperature, coat condition, eye clarity, presence, absence, condition of lesions, posture, loss of righting reflex, seizure state, seizure type, overall animal health, disease state, scratching, and assessment of activities including marble burying or nest building.

5. The system of claim 1, wherein the controller comprises:
a graphics processor unit (GPU);
a central processor unit (CPU); and
a memory, wherein the GPU, the CPU, and the memory are coupled to a shared substrate, wherein the controller is configured to perform machine learning tasks.

6. The system of claim 1, wherein the illumination module comprises:
a plurality of infrared light sources;
a plurality of visible light sources; and
a light diffuser disposed along a downward-facing surface of the housing.

7. The system of claim 6, wherein the plurality of infrared light sources and the plurality of visible light sources are disposed in an interleaved arrangement, wherein the interleaved arrangement is selected so as to evenly illuminate the cage bottom with visible light or infrared light.

8. The system of claim 6, wherein the plurality of infrared light sources are configured to emit infrared light having a wavelength of at least 900 nm or in the near-infrared (NIR) wavelength range from 700 nm to 2.5 microns.

9. The system of claim 1, wherein the top-down camera is configured to capture images at Ultra High Definition (UHD) 4K (4032×3040 pixels) resolution at 30 frames per second.

10. The system of claim 1, wherein the cage housing further comprises:
a food hopper; and
a water bottle holder.

11. The system of claim 10, wherein at least one of the food hopper or the water bottle holder is shaped to so as to reduce occluding the top-down field of view.

12. The system of claim 1, wherein the cage top comprises:
a static vent along a front surface of the cage top, where the static vent is air permeable.

13. The system of claim 1, wherein the air handling system comprises:
at least one fan;
a HEPA filter;
one or more airflow connectors; and
a vibration isolation mechanism.

14. The system of claim 13, wherein the air handling system further comprises a PID controller, wherein the PID controller is configured to control the at least one fan to provide a constant pressure or constant flowrate to the cage housing when attached.

15. The system of claim 13, wherein the vibration isolation mechanism comprises a plurality of spring elements that couple the at least one fan to the housing, wherein the plurality of spring elements are configured to dampen vibrations caused by operation of the at least one fan.

16. The system of claim 13, wherein the cage housing further comprises a plurality of airflow connectors disposed along a rear surface of the cage top, wherein airflow connectors are configured to attachably couple to the air handling system when the cage housing is mounted within the housing.

17. The system of claim 1, further comprising a communication interface, wherein the communication interface communicatively couples the controller to at least one of: a gateway or a central server.

18. The system of claim 1, wherein the cage data unit further comprises an oblique angle camera, wherein the oblique angle camera is configured to capture images of an oblique angle field of view.

19. A rack-mounted cage system comprising:
a base frame;
a plurality of vertical members coupled to the base frame; and
a plurality of bays formed by spaces between the plurality of vertical members, wherein at least a portion of the plurality of bays comprises:
a cage housing comprising:
a cage top; and
a cage bottom;
a cage data unit comprising:
a top-down camera configured to capture images of a top-down field of view including one or more animals housed within the cage housing; and
an illumination module configured to illuminate the top-down field of view;
an air handling system coupled to the cage housing; and
a controller operable to carry out operations, the operations comprising:
causing the top-down camera to capture images of the top-down field of view.

20. A method comprising:
receiving, by way of a central server, images of a top-down field of view, wherein the images comprise live or historical images of one or more animals housed within a cage housing; and
displaying, via a display, a user interface, wherein the user interface comprises:
a video stream viewer, wherein the video stream viewer is configured to display a user-navigable stream of the live or historical images; and
at least one data graph.
